(19) United States
(12) Patent Application Publication
(10) Pub. No.: US 2013/0022902 A1
(43) Pub. Date: Jan. 24, 2013

(54) ELECTROPHOTOGRAPHIC PHOTORECEPTOR, IMAGE FORMING METHOD AND APPARATUS, AND PROCESS CARTRIDGE

(71) Applicants: Keisuke Shimoyama, Shizuoka (JP); Hideo Nakamori, Shizuoka (JP); Noboru Toriu, Shizuoka (JP); Mitsuaki Hirose, Shizuoka (JP); Tomoharu Asano, Shizuoka (JP)

(72) Inventors: Keisuke Shimoyama, Shizuoka (JP); Hideo Nakamori, Shizuoka (JP); Noboru Toriu, Shizuoka (JP); Mitsuaki Hirose, Shizuoka (JP); Tomoharu Asano, Shizuoka (JP)

(21) Appl. No.: 13/548,559

(22) Filed: Jul. 13, 2012

(30) Foreign Application Priority Data
Jul. 19, 2011 (JP) 2011-157511
Jul. 3, 2012 (JP) 2012-149593

(51) Int. Cl. G03G 5/047; G03G 21/16; G03G 13/06; G03G 15/00

(52) U.S. Cl. 430/58.4; 399/159; 399/111; 430/125.3

(57) ABSTRACT

An electrophotographic photoreceptor including an electroconductive substrate; a charge generation layer located overlying the electroconductive substrate; a charge transport layer located overlying the charge generation layer; and an outermost layer located overlying the charge transport layer. The charge transport layer includes a positive hole transport material having the following formula (1):

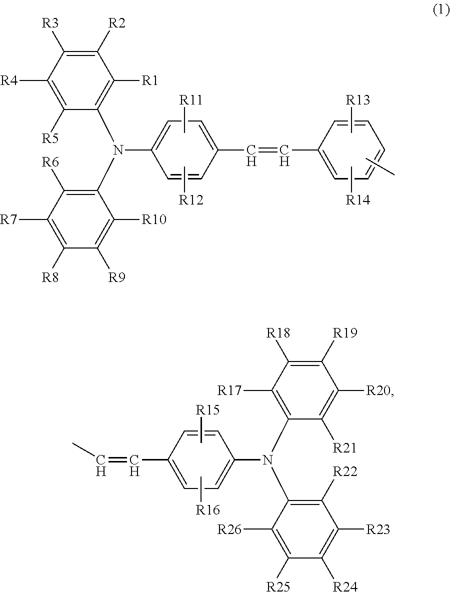

wherein each of R1 to R26 independently represents a hydrogen atom, an alkyl group having 1 to 4 carbon atoms, or an alkoxyl group having 1 to 4 carbon atoms, and a compound having the following formula (2):

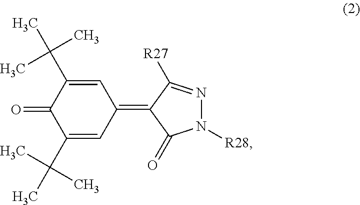

wherein each of R27 and R28 independently represents a substituted or unsubstituted alkyl group, or a substituted or unsubstituted aryl group.

### CROSS-REFERENCE TO RELATED APPLICATIONS

This patent application is based on and claims priority pursuant to 35 U.S.C. §119 to Japanese Patent Applications Nos. 2011-157511 and 2012-149593, filed on Jul. 19, 2011 and Jul. 3, 2012, respectively, in the Japan Patent Office, the entire disclosure of which is hereby incorporated herein by reference.

### FIELD OF THE INVENTION

The present invention relates to an electrophotographic photoreceptor. In addition, the present invention also relates to an image forming method, an image forming apparatus, and a process cartridge, which use the electrophotographic photoreceptor.

### BACKGROUND OF THE INVENTION

Electrophotographic image forming methods used for electrophotographic image forming apparatuses such as laser printers, copiers and facsimiles typically include the following processes:

(1) charging a surface of an electrophotographic photoreceptor (hereinafter referred to as a photoreceptor) serving as an image bearing member (charging process);
(2) irradiating the charged surface of the photoreceptor with light so that the charges of the irradiated portions decay, thereby forming an electrostatic latent image on the surface of the photoreceptor (irradiating process);
(3) developing the electrostatic latent image with a developer including a charged toner to form a visible toner image on the photoreceptor (developing process);
(4) transferring the toner image to a recording material such as a paper sheet optionally via an intermediate transfer medium (transferring process);
(5) fixing the toner image to the recording material upon application of heat and/or pressure (fixing process); and
(6) cleaning the surface of the photoreceptor so that the photoreceptor is ready for the next image forming operation (cleaning process).

Since recent electrophotographic image forming apparatus can stably produce high quality images, electrophotographic image forming apparatus have been broadly used. Photoreceptors used for such image forming apparatuses have a function of forming an electrostatic latent image by being subjected to a charging process and an irradiating process, and a function of forming a visible image by being subjected to a developing process.

Photoreceptors are classified into inorganic photoreceptors and organic photoreceptors, and organic photoreceptors have been broadly used recently because of having advantages in cost, productivity, flexibility in selection of constitutional materials, and environmental protection. Organic photoreceptors include, as a main layer, a photosensitive layer including a photosensitive material, and are broadly classified into single-layer type photoreceptors including a photosensitive layer having a combination of a charge generation function and a charge transport function, and functionally separated multi-layer type photoreceptors including a charge generation layer and a charge transport layer.

The mechanism of forming an electrostatic latent image on a functionally separated multi-layer photoreceptor is that when the surface of the photoreceptor, which is charged uniformly, is irradiated with light, light transmits the charge transport layer and is absorbed by the charge generation material in the charge generation layer, thereby generating charges (i.e., a pair of charges). One of the pair of charges is injected into the charge transport layer from the interface between the charge generation layer and the charge transport layer, and the injected charges are transported to the surface of the photoreceptor due to the electric field formed on the photoreceptor, thereby neutralizing the charges formed on the surface of the photoreceptor in the charging process, resulting in formation of an electrostatic latent image on the surface of the photoreceptor.

Since multi-layer type photoreceptors have advantages in stability of electrostatic property and durability, the multi-layer type photoreceptors become the mainstream of photoreceptors at the present time.

Since recent electrophotographic image forming apparatus using such an organic photoreceptor can form full color images and/or perform high speed image formation, electrophotographic image forming apparatus have been used for various fields such as SOHO (small office home office) and printing fields as well as for popular offices. Particularly, in the printing fields, the number of prints formed by an electrophotographic image forming apparatus is much greater than the number of prints formed by an electrophotographic image forming apparatus in an office, and in addition the requirement for image quality is severer in the printing fields. Therefore, it is necessary for electrophotographic image forming apparatus to improve the durability and the stability.

In attempting to improve the durability of photoreceptor, there are proposals in which a crosslinking material such as a thermosetting resin and an UV crosslinking resin is used for forming an outermost layer of a photoreceptor. For example, there are proposals in which a thermosetting resin is used as a binder resin of an outermost layer of a photoreceptor to improve the abrasion resistance and the scratch resistance of the photoreceptor. In addition, there are proposals in which a siloxane resin having a crosslinking structure is used as a charge transport material to improve the abrasion resistance and the scratch resistance of the photoreceptor. Further, there are proposals in which a monomer having a C—C double bond, a charge transport material having a C—C double bond, and a binder resin having a C—C double bond are used to improve the abrasion resistance and the scratch resistance of the photoreceptor. These photoreceptors have good mechanical durability.

However, the durability of photoreceptor is not limited to such mechanical durability, and electrostatic durability is also important. Specifically, when a photoreceptor is repeatedly subjected to a charging process and an irradiating process, the photoreceptor causes problems in which the electrostatic property of the photoreceptor changes (such as increase of the potential of an irradiated portion (i.e., residual potential, hereinafter referred to as irradiated-portion potential) of the photoreceptor and decrease of the potential of a dark portion of the photoreceptor (hereinafter referred to as dark-portion potential)), and thereby the image density varies; and the photoreceptor is damaged by oxidizing gases generated by a charger used for the charging process, thereby forming blurred images. Therefore, a photoreceptor having good mechanical durability due to a crosslinked outermost layer formed thereon has to maintain good electrostatic durability for a long period of time.

In attempting to prevent formation of blurred images by enhancing the resistance of photoreceptor to gasses (such as oxidizing gasses), there are proposals in which an antioxidant is included in a photosensitive layer or an outermost layer of a photoreceptor. However, conventional antioxidants have only small blurred image preventing effect, and typically produce an adverse effect such that the irradiated-portion potential of the photoreceptor increases. Specifically, when a large amount of an antioxidant is included in a photoreceptor to prevent formation of blurred images, the potential of an irradiated portion increases, thereby causing a problem in which images having a low image density are produced by the photoreceptor.

In addition, in attempting to prevent formation of blurred images, there are proposals in which a compound having an alkylamino group is included in a photosensitive layer or an outermost layer. Since this technique has good blurred image preventing effect while producing a smaller adverse effect than antioxidants, the technique can be used for conventional photoreceptors, which are not required to have such good durability as needed for photoreceptors used for printing fields. In other words, the durability improving effects produced by this technique are not sufficient for photoreceptors used for printing fields.

The mechanism of forming blurred images is considered to be that when a photoreceptor is exposed to oxidizing gasses generated by a charger, constitutional materials of the photoreceptor such as charge transport materials are altered, thereby forming blurred images. Antioxidants and the above-mentioned compounds having an alkylamino group are considered to act on oxidizing gasses in priority, thereby suppressing alteration of constitutional materials of the photoreceptor. However, since the antioxidants and the compounds having an alkylamino group are decomposed or altered, the decomposed materials or the altered materials serve as traps in the photosensitive layer, thereby increasing the irradiated-portion potential of the photoreceptor. Therefore, formation of blurred images cannot be prevented thereby.

In the problem in which the potential of an irradiated portion of a photoreceptor changes when the photoreceptor is used for printing fields, variation in potential of the photoreceptor in a case where an image forming operation is started after an image forming operation is ended (hereinafter referred to as job-to-job potential variation) is greater than variation in a case where images are repeatedly formed for a relatively long period of time (hereinafter referred to as diurnal potential variation). The reason is as follows. Specifically, even when the diurnal potential variation is caused, the effect thereof is hardly noticeable, and in addition the image forming apparatus typically performs a potential adjusting operation. Therefore, a serious problem is not caused. In contrast, in the job-to-job potential variation, the effect thereof is visible, and if the potential varies at a cycle of several image forming operations or tens of image forming operations, it is difficult to perform a potential adjusting operation, thereby causing a serious problem.

Particularly, there is a case where a large number of copies of an image are produced in printing. When a large job-to-job potential variation is caused in such a case, the image density of the copies varies, thereby deteriorating the consistency in image qualities. If the image is a character image, change of the image qualities is hardly noticeable, but when the image is a pictorial full color image, not only the image density but also the color tone changes, resulting in occurrence of a serious problem. Therefore, when a photoreceptor is used for printing fields, the photoreceptor is required to have a low irradiation potential while having small job-to-job potential variation as well as small diurnal potential variation.

In attempting to improve the electrostatic stability of photoreceptor, there are proposals in which a specific acceptor compound is included in a charge transport layer. In addition, in attempting to improve the resistance to light, there is a proposal in which a specific charge transport material and a specific additive are included in a charge transport layer. However, the improving effects of the techniques change depending on the hole transport materials used for the photoreceptors, or the improving effects are insufficient for photoreceptors used for printing fields, which are required to have a low irradiation potential while having small job-to-job potential variation as well as small diurnal potential variation.

For these reasons, the inventors recognized that there is a need for a photoreceptor which has good durability so as to be repeatedly used for a long period of time without producing blurred images and which has small job-to-job potential variation as well as small diurnal potential variation.

### BRIEF SUMMARY OF THE INVENTION

As an aspect of the present invention, a photoreceptor is provided which includes an electroconductive substrate, a charge generation layer located overlying the electroconductive substrate, a charge transport layer located overlying the charge generation layer, and an outermost layer located overlying the charge transport layer. The charge transport layer includes a positive hole transport material having the following formula (1):

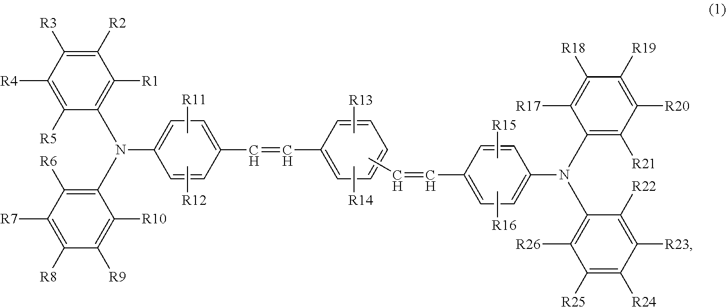

wherein each of R1 to R26 independently represents a hydrogen atom, an alkyl group having 1 to 4 carbon atoms, or an alkoxyl group having 1 to 4 carbon atoms, and a compound having the following formula (2):

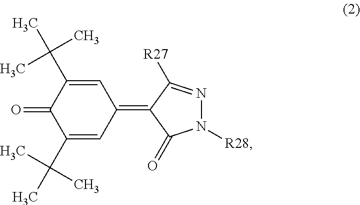

wherein each of R27 and R28 independently represents a substituted or unsubstituted alkyl group, or a substituted or unsubstituted aryl group.

As another aspect of the present invention, an image forming method is provided which includes charging a surface of the above-mentioned photoreceptor, irradiating the charged surface of the photoreceptor with light to form an electrostatic latent image on the surface of the photoreceptor, developing the electrostatic latent image with a developer including a toner to form a toner image on the surface of the photoreceptor, and transferring the toner image onto a receiving material such as an intermediate transfer medium or a recording material.

As yet another aspect of the present invention, an image forming apparatus is provided which includes the above-mentioned photoreceptor, a charger to charge a surface of the photoreceptor, an irradiator to irradiate the charged surface of the photoreceptor with light to form an electrostatic latent image on the surface of the photoreceptor, a developing device to develop the electrostatic latent image with a developer including a toner to form a toner image on the surface of the photoreceptor, and a transferring device to transfer the toner image onto a receiving material such as an intermediate transfer medium or a recording material.

As a further aspect of the present invention, a process cartridge is provided which includes the above-mentioned photoreceptor, and at least one of a charger to charge a surface of the photoreceptor, a developing device to develop an electrostatic latent image on the surface of the photoreceptor with a developer including a toner to form a toner image on the surface of the photoreceptor, a transferring device to transfer the toner image onto a receiving material such as an intermediate transfer medium or a recording material, a cleaner to clean the surface of the photoreceptor after transferring the toner image, and a discharger to discharge residual charges remaining on the photoreceptor after transferring the toner image, which are integrated into a single unit so as to be detachably attachable to an image forming apparatus.

The aforementioned and other aspects, features and advantages will become apparent upon consideration of the following description of the preferred embodiments taken in conjunction with the accompanying drawings.

### BRIEF DESCRIPTION OF THE SEVERAL VIEWS OF THE DRAWINGS

FIG. 1 is a schematic cross-sectional view illustrating an example of the photoreceptor of the present invention;

FIG. 2 is a schematic cross-sectional view illustrating an example of the image forming apparatus of the present invention;

FIG. 3 is a schematic cross-sectional view illustrating an example of the process cartridge of the present invention; and

FIG. 4 is the X-ray diffraction spectrum of a titanyl phthalocyanine used for examples of the photoreceptor of the present invention.

### DETAILED DESCRIPTION OF THE INVENTION

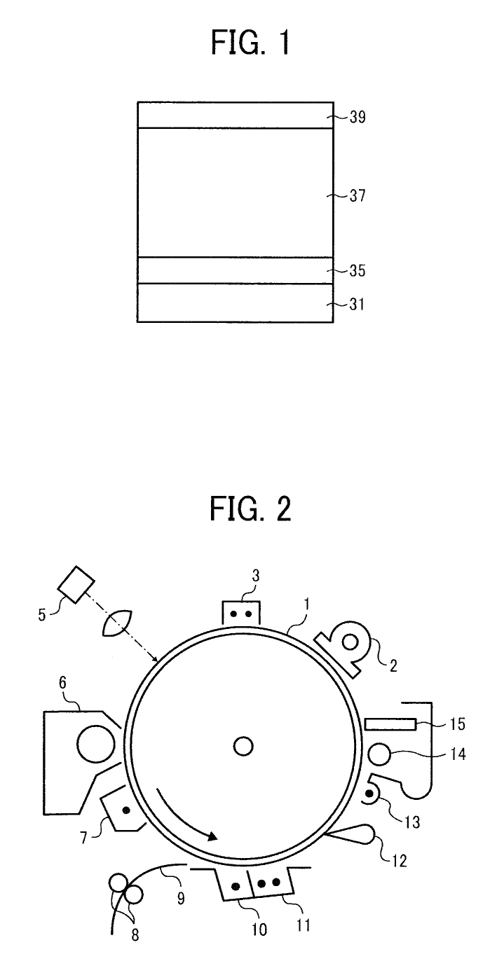

The photoreceptor of the present invention will be described by reference to FIG. 1. The photoreceptor of the present invention includes an electroconductive substrate 31, a charge generation layer 35 located overlying the electroconductive substrate, a charge transport layer 37 located overlying the charge generation layer 35, and an outermost layer 39 located overlying the charge transport layer 37. The charge transport layer 37 includes a positive hole transport material having the following formula (1):

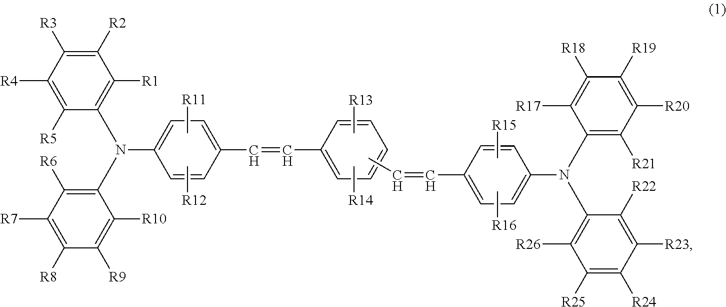

wherein each of R1 to R26 independently represents a hydrogen atom, an alkyl group having 1 to 4 carbon atoms, or an alkoxyl group having 1 to 4 carbon atoms, and a compound having the following formula (2):

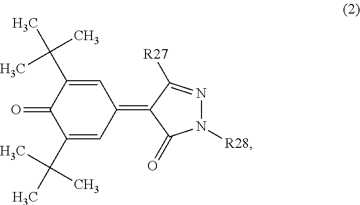

wherein each of R27 and R28 independently represents a substituted or unsubstituted alkyl group, or a substituted or unsubstituted aryl group.

In this regard, “overlying” can include direct contact and allow for one or more intermediate layers.

The electroconductive substrate 31 is not particularly limited as long as the substrate has a volume resistivity of not greater than 10¹⁰ Ω·cm. Specific examples of such materials include plastic cylinders, plastic films or paper sheets, on the surface of which a layer of a metal such as aluminum, nickel, chromium, nichrome, copper, gold, silver and platinum, or a layer of a metal oxide such as tin oxides and indium oxides, is formed by deposition or sputtering. In addition, a plate of a metal such as aluminum, aluminum alloys, nickel and stainless steel can be used. A metal cylinder, which is prepared by tubing a metal such as aluminum, aluminum alloys, nickel and stainless steel using a method such as impact ironing or direct ironing, and then subjecting the surface of the tube to one or more treatments such as cutting, super finishing and polishing, can also be used as the substrate. Further, endless nickel or stainless steel belts disclosed in published unexamined Japanese patent application No. 52-36016 can also be used as the electroconductive substrate 31.

Furthermore, substrates, in which a coating liquid including a binder resin and an electroconductive powder is coated on the supports mentioned above, can be used as the electroconductive substrate 31. Specific examples of such an electroconductive powder include carbon black, acetylene black, powders of metals such as aluminum, nickel, iron, nichrome, copper, zinc and silver, and powders of metal oxides such as electroconductive tin oxides and ITO. Specific examples of the binder resin include known thermoplastic resins, thermosetting resins and photo-crosslinking resins, such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonates, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins and alkyd resins.

Such an electroconductive layer can be formed by coating a coating liquid in which an electroconductive powder and a binder resin are dispersed or dissolved in a proper solvent such as tetrahydrofuran, dichloromethane, methyl ethyl ketone and toluene, and then drying the coated liquid.

In addition, substrates, in which an electroconductive resin film is formed on a surface of a cylindrical substrate using a heat-shrinkable resin tube which is made of a combination of a resin (such as polyvinyl chloride, polypropylene, polyesters, polyvinylidene chloride, polyethylene, chlorinated rubber and fluorine-containing resins (such as TEFLON)) and an electroconductive material, can also be used as the electroconductive substrate 31.

The charge generation layer 35 includes a charge generation material as a main component. Known charge generation materials can be used as the charge generation material. Specific examples thereof include monazo pigments, disazo pigments, trisazo pigments, perylene pigments, perynone pigments, quinacridone pigments, polycyclic quinone pigments, squaric acid dyes, phthalocyanine pigments, naphthalocyanine pigments and azulenium salt type pigments. These charge generation materials can be used alone or in combination.

The method for forming the charge generation layer 35 is not particularly limited. Specific examples thereof include a method including preparing a coating liquid by dispersing a charge generation material in a solvent optionally together with a binder resin using a dispersing machine such as ball mills, attritors, sand mills, and ultrasonic dispersing machines; and coating the coating liquid, which is optionally diluted, on an electroconductive substrate, followed by drying the coated liquid, to prepare the charge generation layer.

Specific examples of the binder resin, which is optionally included in the charge generation layer coating liquid, include polyamide, polyurethane, epoxy resins, polyketone, polycarbonate, silicone resins, acrylic resins, polyvinyl butyral, polyvinyl formal, polyvinyl ketone, polystyrene, polysulfone, poly-N-vinylcarbazole, polyacrylamide, polyvinyl benzal, polyester, phenoxy resins, vinyl chloride-vinyl acetate copolymers, polyvinyl acetate, polyphenylene oxide, polyvinyl pyridine, cellulose resins, casein, polyvinyl alcohol and polyvinyl pyrrolidone. These resins can be used alone or in combination. The added amount of a binder resin is generally from 0 to 500 parts by weight, and preferably from 10 to 300 parts by weight, per 100 parts by weight of the charge generation material included in the charge generation layer. In this regard, when a binder resin is added, the binder resin is mixed with the charge generation material before or after the charge generation material dispersing operation.

Specific examples of the solvent for use in preparing the charge generation layer coating liquid include organic solvents such as isopropanol, acetone, methyl ethyl ketone, cyclohexanone, tetrahydrofuran, dioxane, ethyl cellosolve, ethyl acetate, methyl acetate, dichloromethane, dichloroethane, monochlorobenzene, cyclohexane, toluene, xylene and ligroin. Among these solvents, ketone, ester and ether solvents are preferably used. These solvents can be used alone or in combination.

The charge generation layer coating liquid typically includes a charge generation material, a solvent and a binder resin as main components, and can further include additives such as sensitizers, dispersants, surfactants and silicone oils.

The charge generation layer is typically prepared by coating the above-mentioned charge generation layer coating liquid on an electroconductive substrate with an optional undercoat layer therebetween, followed by drying. Suitable coating methods include known coating methods such as dip coating, spray coating, bead coating, nozzle coating, spinner coating and ring coating.

The thickness of the charge generation layer 35 is generally from 0.01 μm to 5 μm, and preferably from 0.1 μm to 2 μm.

The charge transport layer includes a charge transport material and a binder resin as main components. The charge transport layer includes at least a positive hole transport material having the following formula (1) and a compound having the following formula (2):

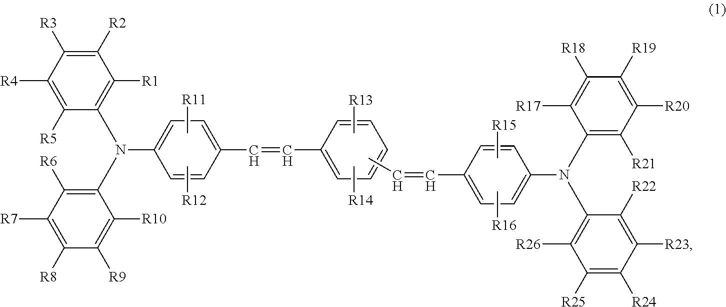

wherein each of R1 to R26 independently represents a hydrogen atom, an alkyl group having 1 to 4 carbon atoms, or an alkoxyl group having 1 to 4 carbon atoms, and

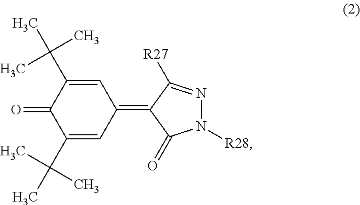

wherein each of R27 and R28 independently represents a substituted or unsubstituted alkyl group, or a substituted or unsubstituted aryl group.

In this regard, each of R27 and R28 is preferably an unsubstituted phenyl group, a phenyl group substituted with a halogen atom, a phenyl group substituted with an alkyl group having 1 to 4 carbon atoms, or an alkyl group having 1 to 4 carbon atoms.

Specific examples of the positive hole transport material having formula (1) include the following, but are not limited thereto.

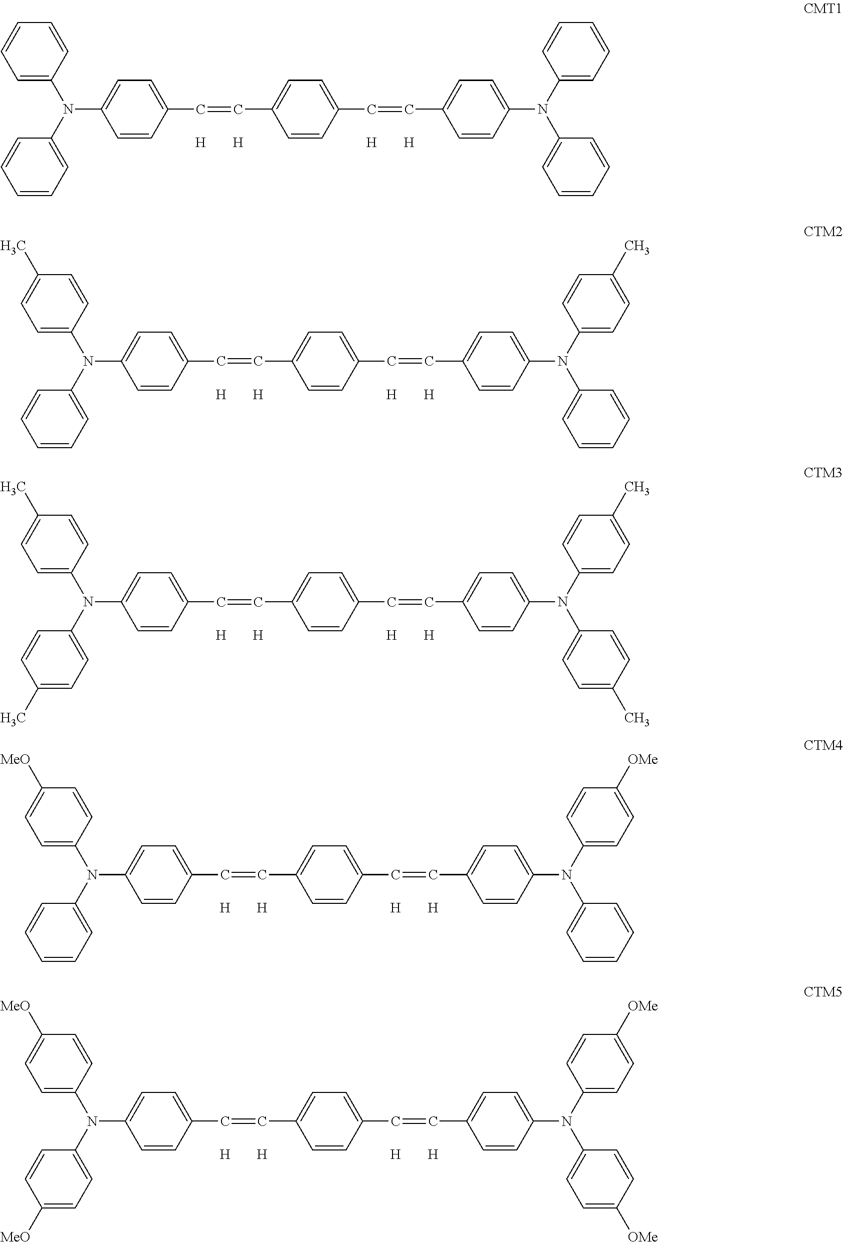

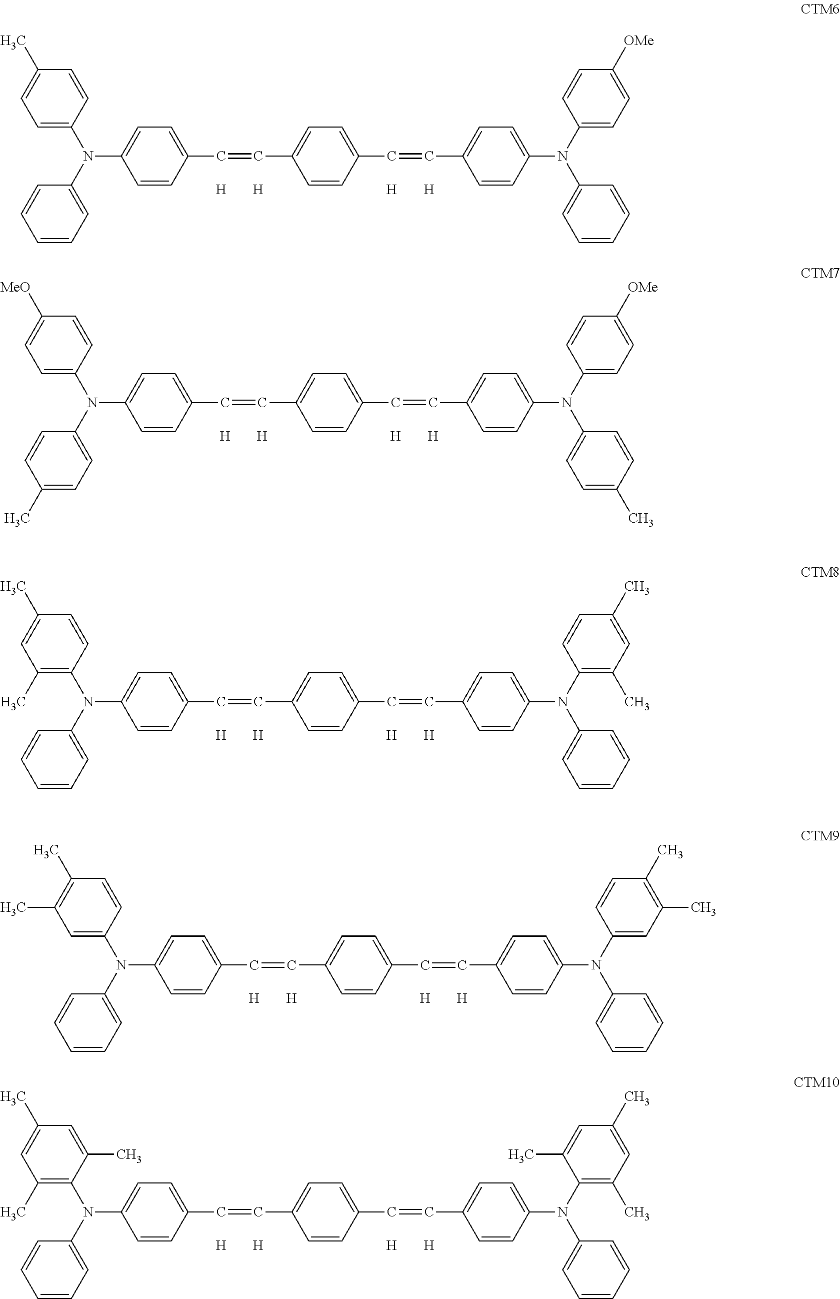

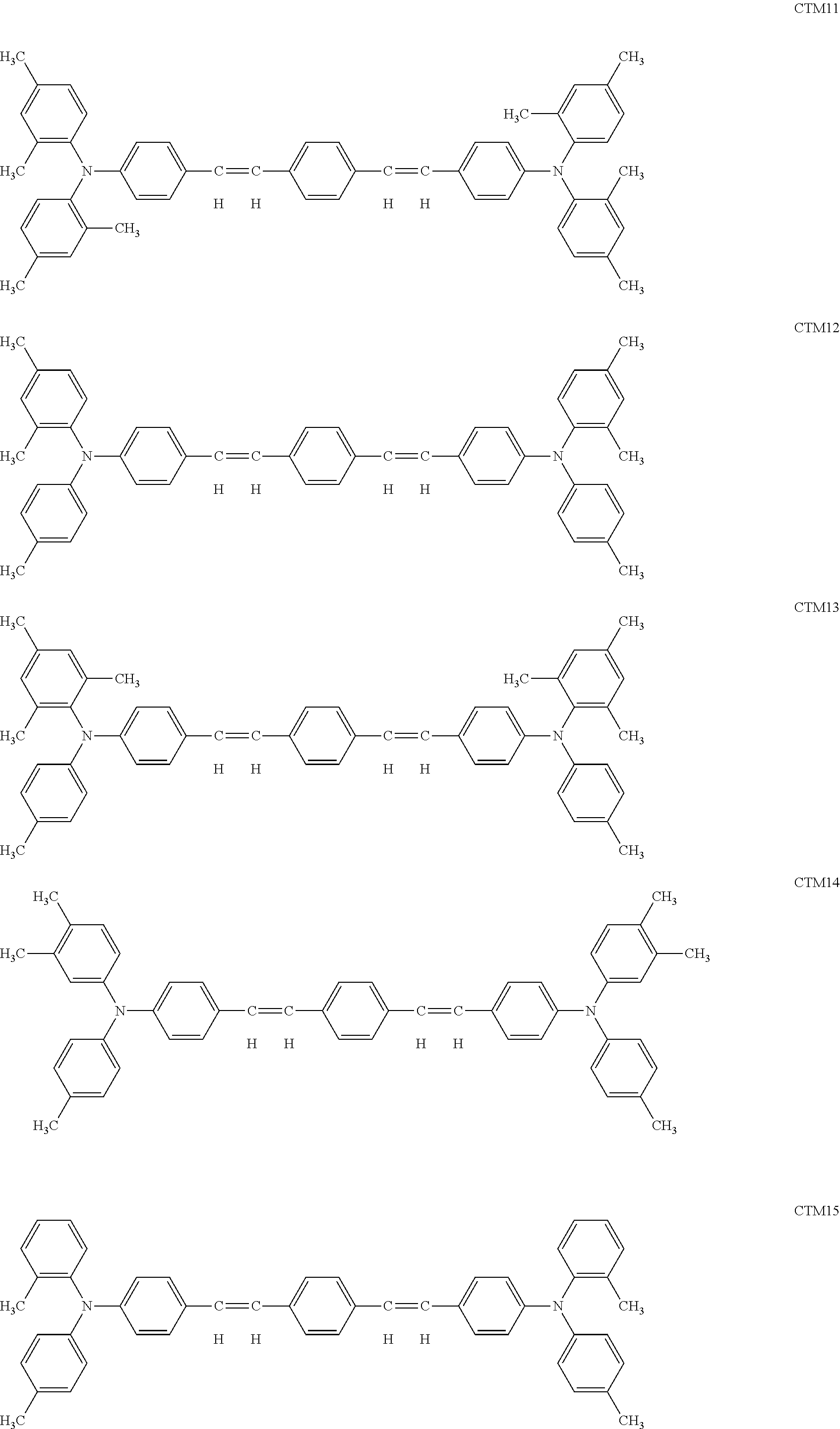

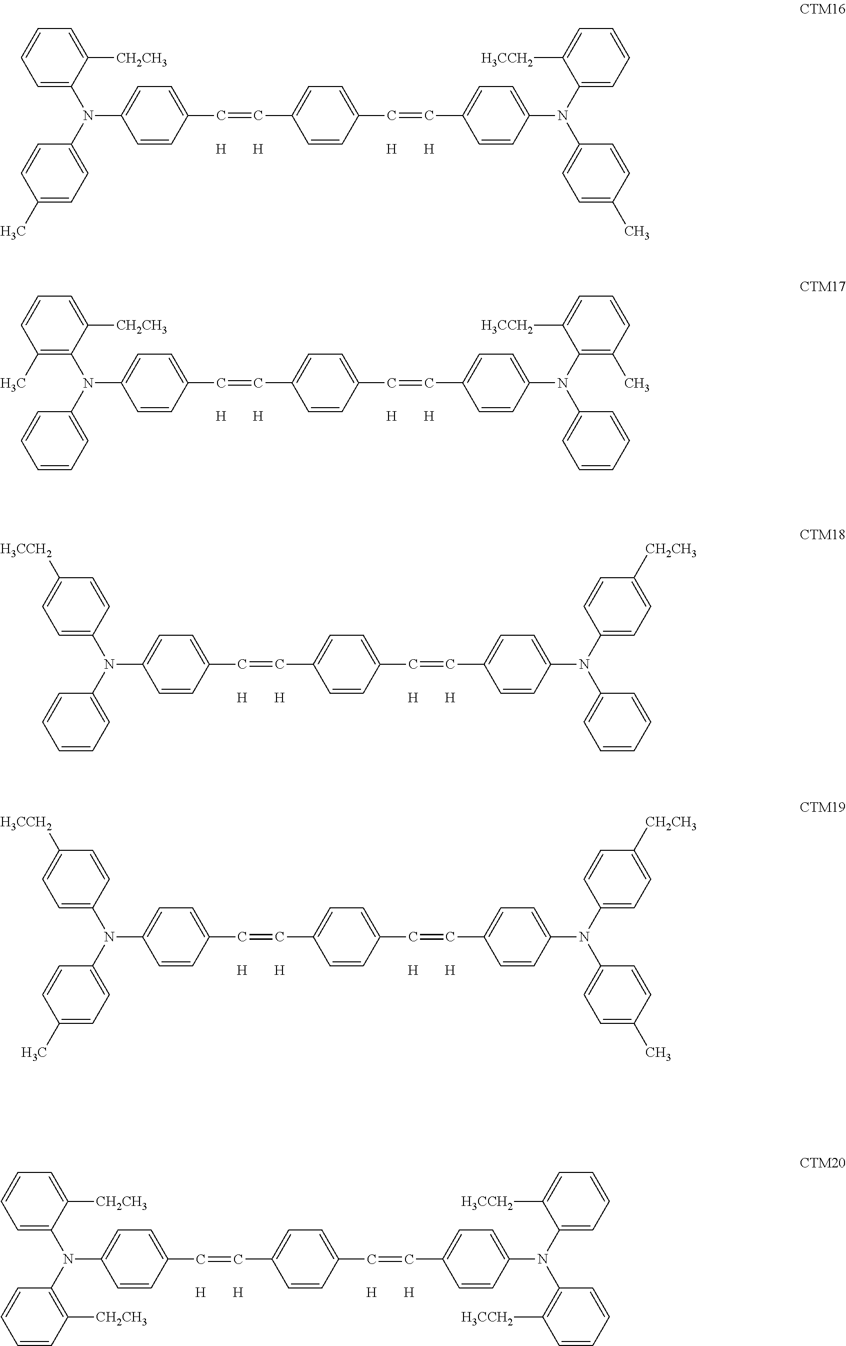

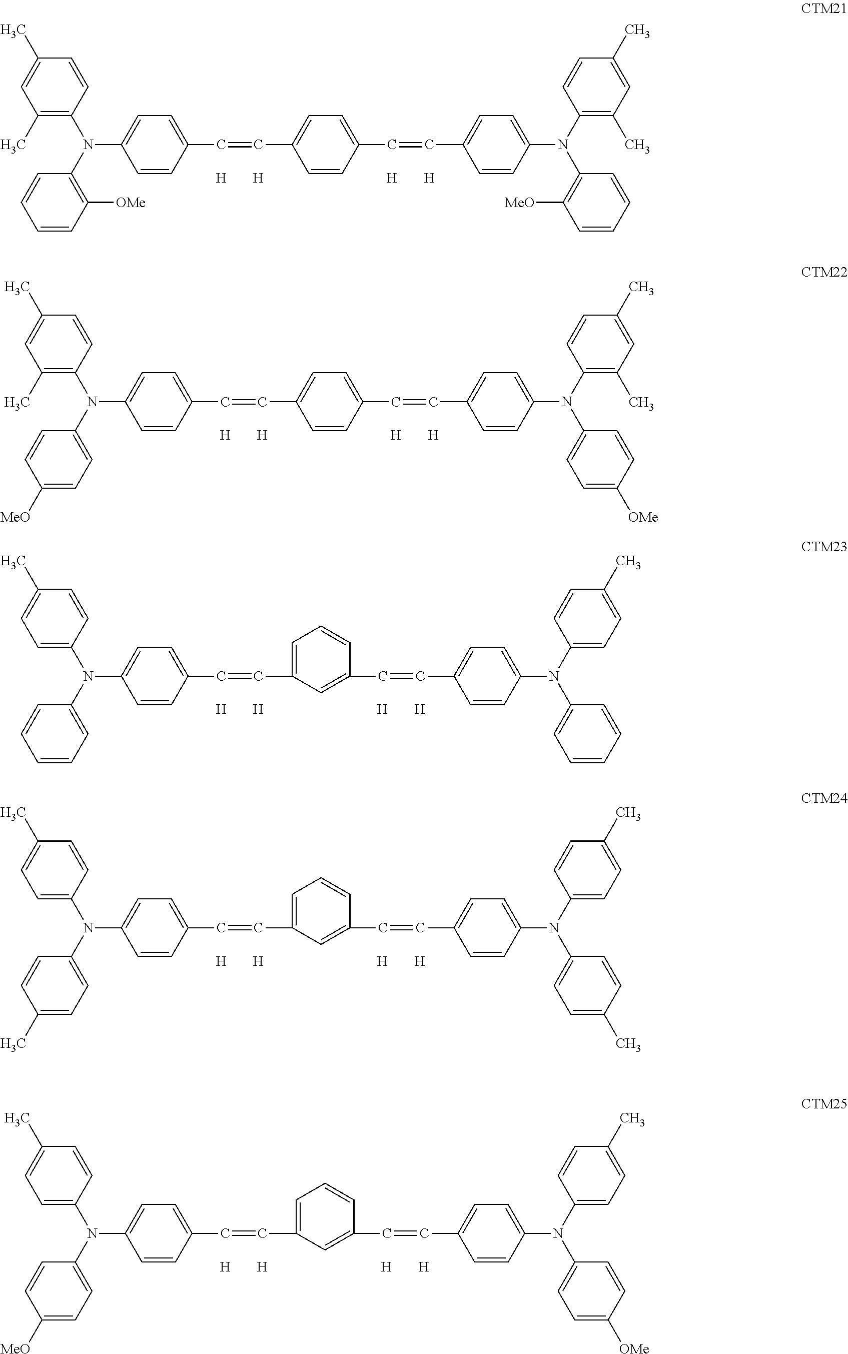

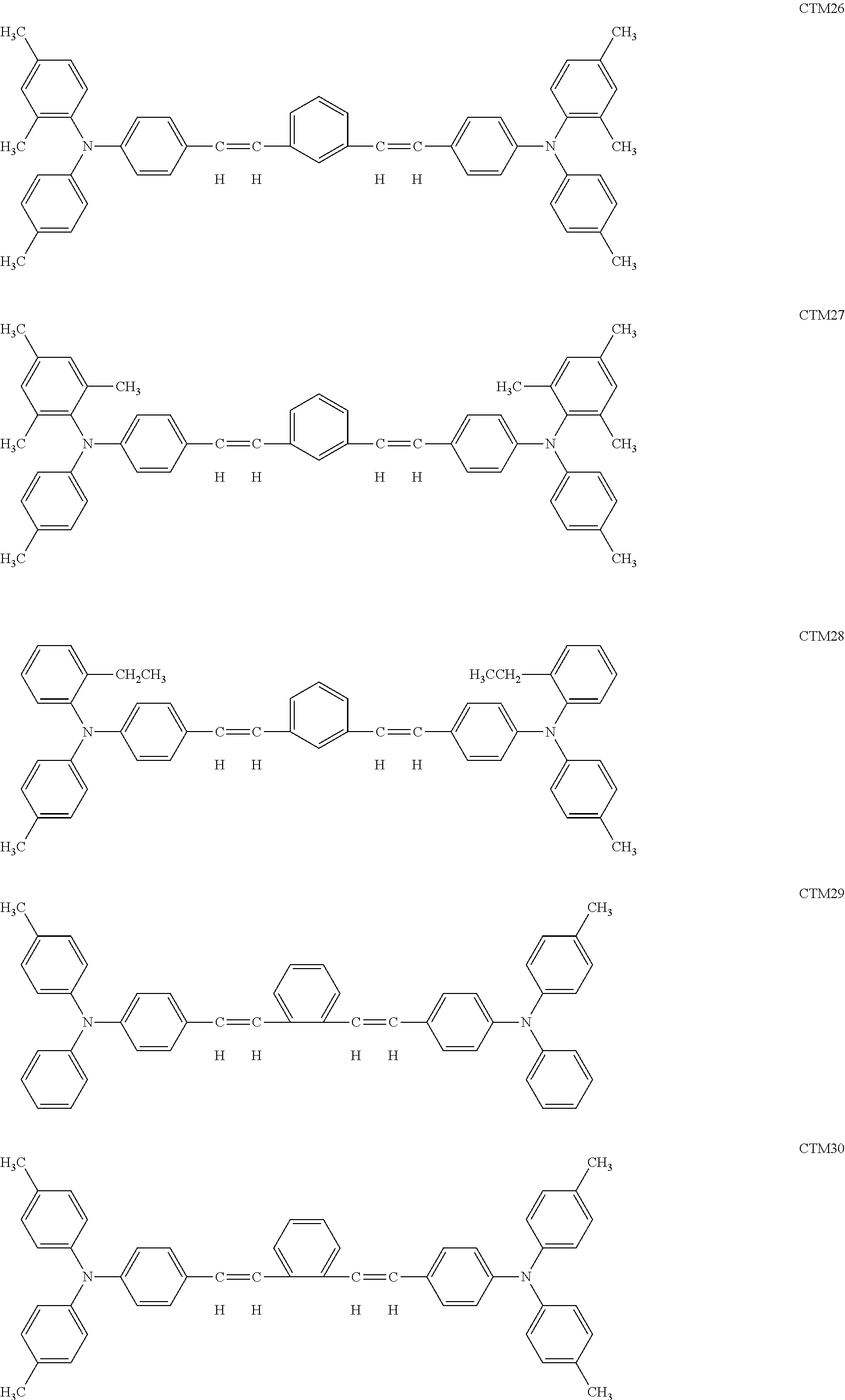

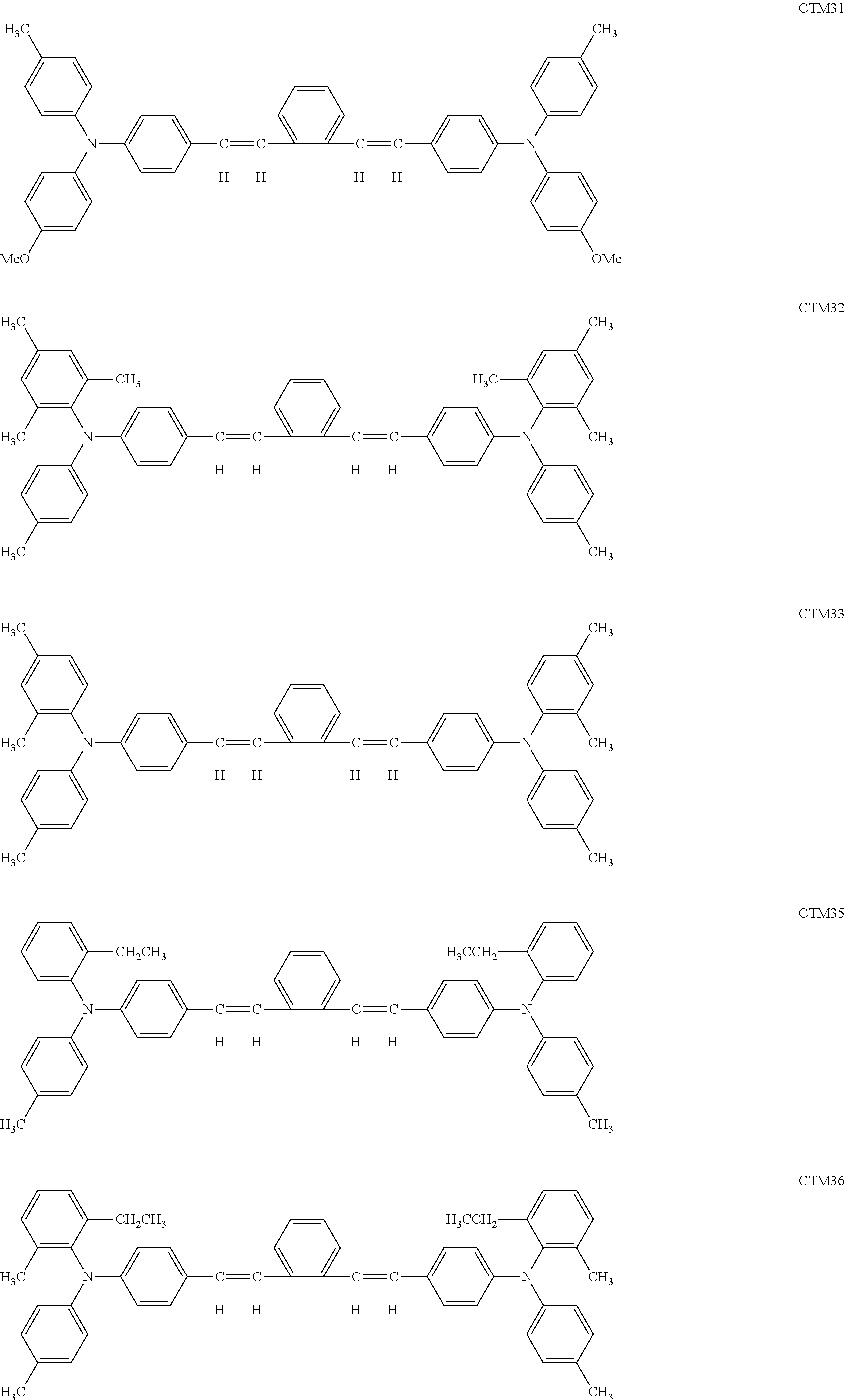

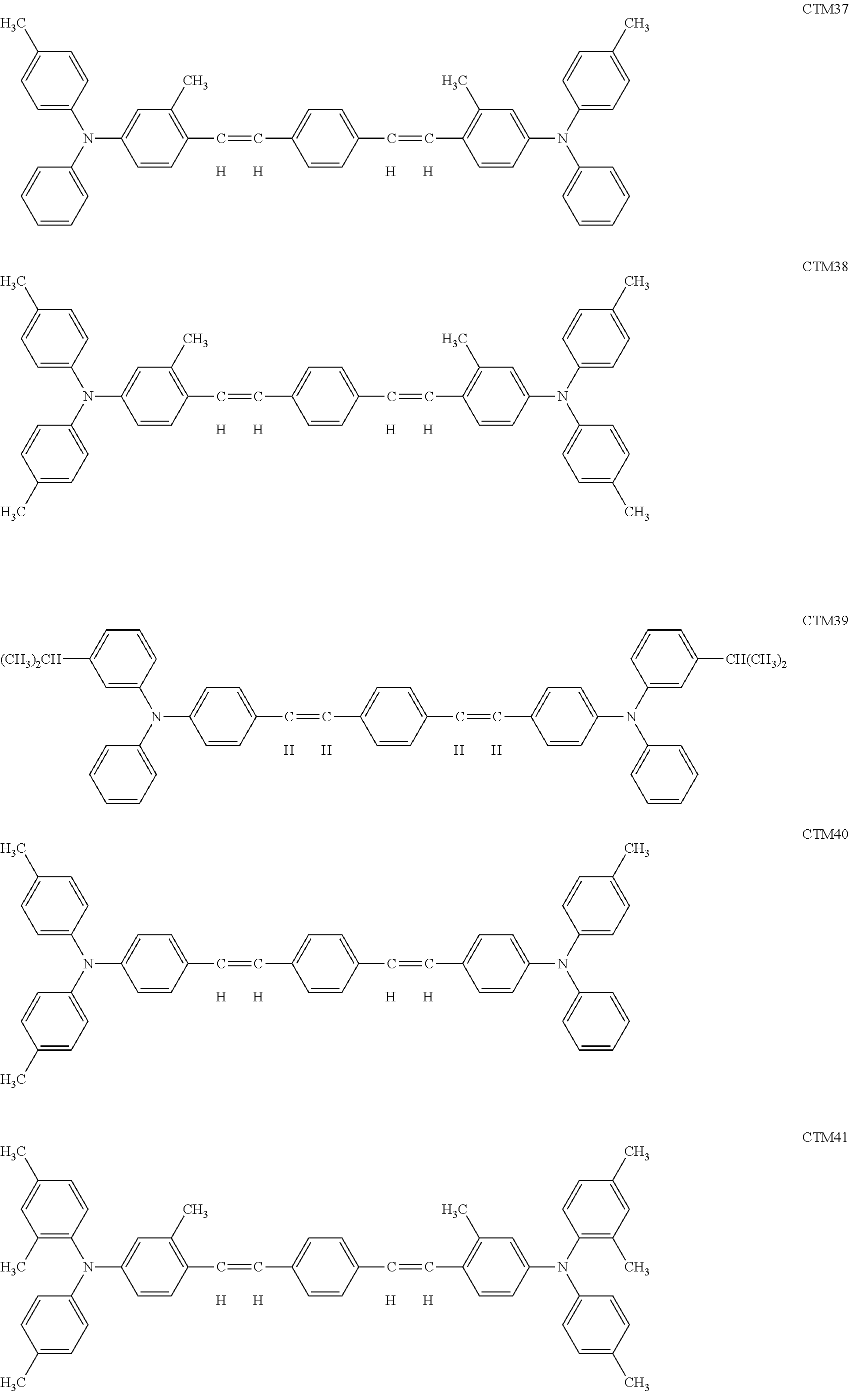

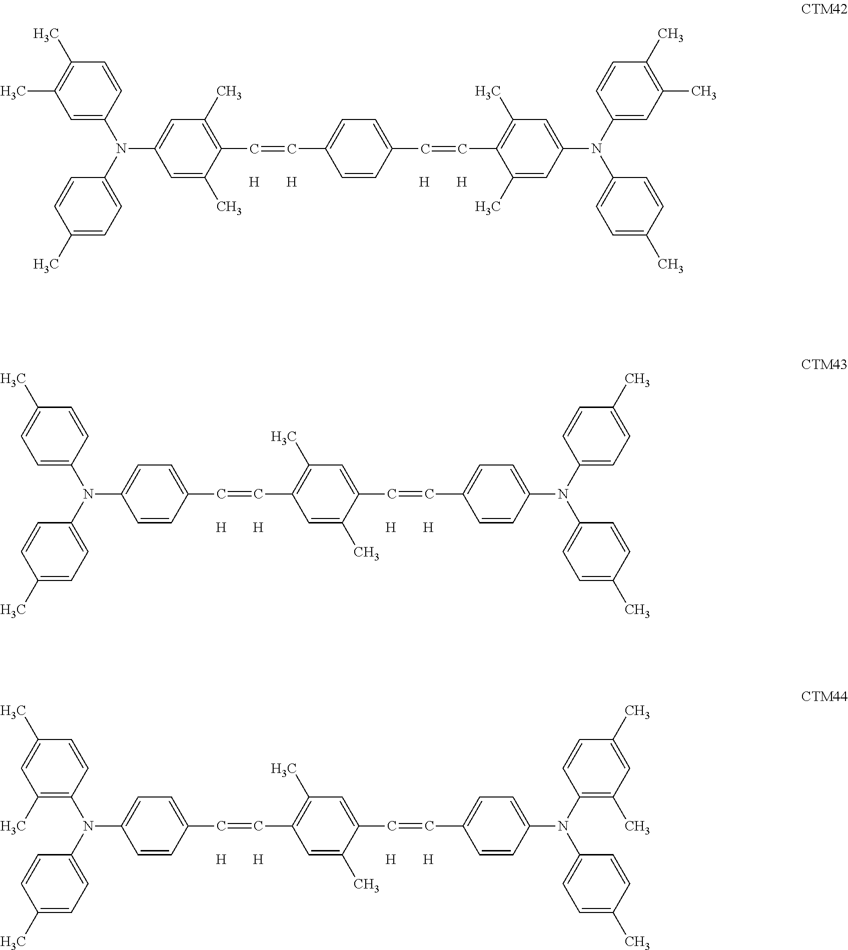

Specific examples of the compound having formula (2) include the following, but are not limited thereto.

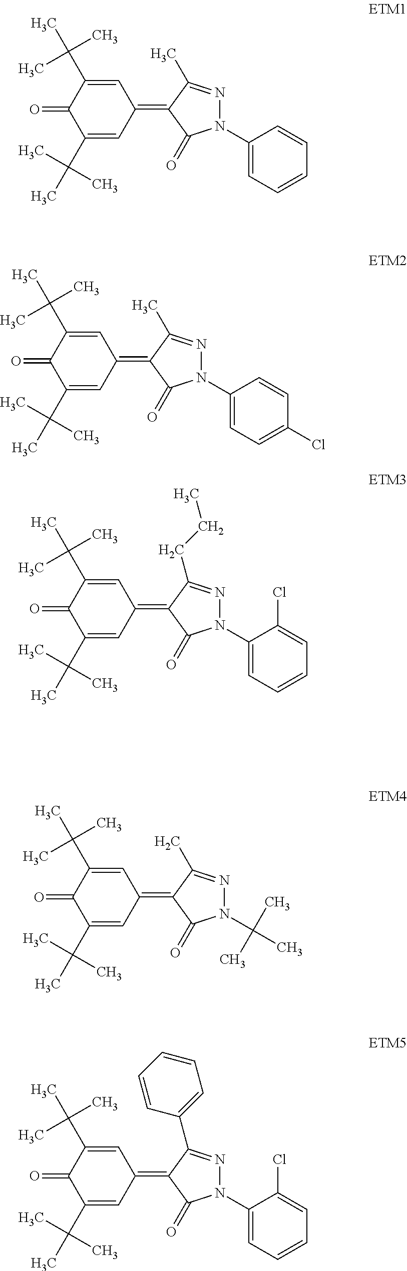 [SMILES: CC1=NN(c2ccccc2)C(=O)C1=C1C=C(C(C)(C)C)C(=O)C(C(C)(C)C)=C1 ; CC1=NN(c2ccc(Cl)cc2)C(=O)C1=C1C=C(C(C)(C)C)C(=O)C(C(C)(C)C)=C1 ; CCCC1=NN(c2ccccc2Cl)C(=O)C1=C1C=C(C(C)(C)C)C(=O)C(C(C)(C)C)=C1 ; CC1=NN(C(C)(C)C)C(=O)C1=C1C=C(C(C)(C)C)C(=O)C(C(C)(C)C)=C1 ; CC(C)(C)C1=CC(=C2C(=O)N(c3ccccc3Cl)N=C2c2ccccc2)C=C(C(C)(C)C)C1=O]

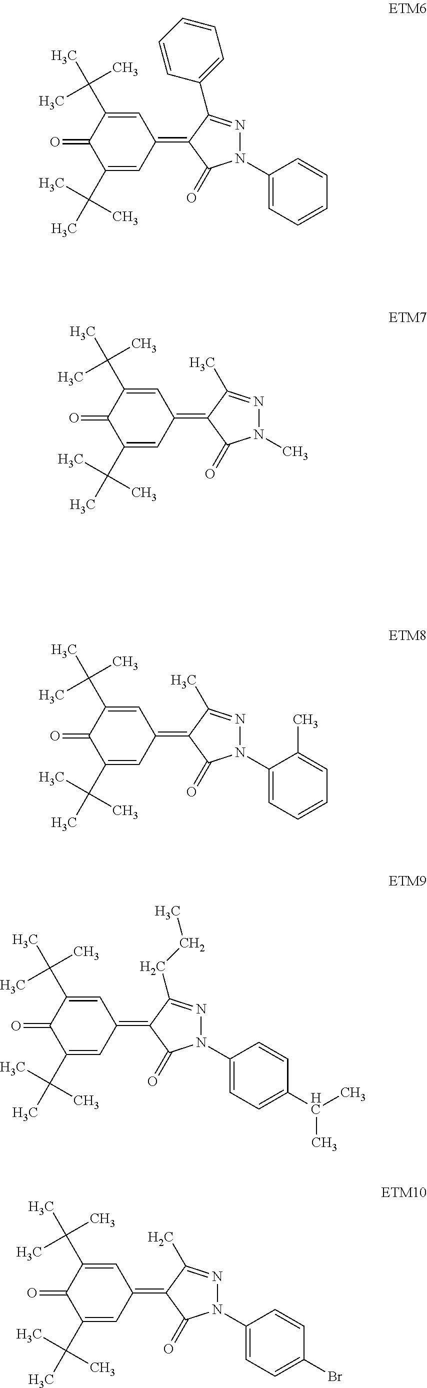 [SMILES: CC(C)(C)C1=CC(=C2C(=O)N(c3ccccc3)N=C2c2ccccc2)C=C(C(C)(C)C)C1=O ; CC1=NN(C)C(=O)C1=C1C=C(C(C)(C)C)C(=O)C(C(C)(C)C)=C1 ; CC1=NN(c2ccccc2C)C(=O)C1=C1C=C(C(C)(C)C)C(=O)C(C(C)(C)C)=C1 ; CCCC1=NN(c2ccc(C(C)C)cc2)C(=O)C1=C1C=C(C(C)(C)C)C(=O)C(C(C)(C)C)=C1 ; CC1=NN(c2ccc(Br)cc2)C(=O)C1=C1C=C(C(C)(C)C)C(=O)C(C(C)(C)C)=C1]

By using a positive hole transport material having formula (1) for the charge transport layer, the resultant photoreceptor has a high sensitivity, small job-to-job variation, and a low irradiated-portion potential. However, the photoreceptor has insufficient chemical stability, i.e., the photoreceptor tends to be deteriorated by oxidizing gasses.

Since the photoreceptor of the present invention has an outermost layer (described later in detail), the photoreceptor is protected from oxidizing gasses to some extent. However, oxidizing gasses gradually penetrate into the photoreceptor, and reach the charge transport layer. Therefore, the positive hole transport material present at the interface between the charge transport layer and the outermost layer is exposed to the oxidizing gasses little by little, and therefore it is probable that when the photoreceptor is used for a long period of time, the photoreceptor forms blurred images.

However, when a compound having formula (2) is present in the charge transport layer, formation of blurred images can be prevented even when the photoreceptor is used for a long period of time. The reason therefor is considered to be that since a compound having formula (2) is an acceptor, the compound forms a charge transfer complex with a positive hole transport material having formula (1) included in the charge transport layer, thereby preventing occurrence of a reaction of the positive hole transport material with oxidizing gasses. In addition, since a compound having formula (2) is not reactive with oxidizing gasses unlike antioxidants, the compound is not decomposed or deteriorated, and therefore increase of the job-to-job potential variation can be prevented for a long period of time.

When the outermost layer includes a crosslinked resin, the abrasion resistance of the photoreceptor is enhanced, and therefore the photoreceptor can be used for a longer period of time than photoreceptors with an outermost layer including no crosslinked resin. However, since such a crosslinked resin has a three-dimensional network structure, oxidizing gasses can easily penetrate through the outermost layer, and therefore blurred images are easily formed. In contrast, in the photoreceptor of the present invention using a positive hole transport material having formula (2) and a compound having formula (2), blurred images are hardly formed as mentioned above. Therefore, even when a crosslinked resin is used for the outermost layer, formation of blurred images, and increase of the job-to-job potential variation can be prevented.

Specific examples of the binder resin included in the charge transport layer include known thermoplastic resins, and thermosetting resins, such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonates, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins and alkyd resins.

The content of a positive hole transport material having formula (1) in the charge transport layer is from 20 to 300 parts by weight, and preferably from 40 to 150 parts by weight, per 100 parts by weight of the binder resin included in the charge transport layer.

The content of a compound having formula (2) in the charge transport layer is from 0.5 to 10 parts by weight, and preferably from 1 to 5 parts by weight, per 100 parts by weight of the positive hole transport material having formula (1) included in the charge transport layer. When the content of a compound having formula (2) is too low, the effects of the present invention are hardly produced. In contrast, when the content is too high, the irradiated-portion potential and the job-to-job potential variation increase.

The method for preparing the charge transport layer is not particularly limited. For example, a method including preparing a charge transport layer coating liquid by dissolving or dispersing a charge transport material and a binder resin in a solvent; coating the coating liquid on the charge generation layer; and drying the coated liquid, can be used.

Specific examples of the solvent for use in the charge transport layer coating liquid include tetrahydrofuran, dioxane, toluene, dichloromethane, monochlorobenzene, dichloroethane, cyclohexanone, methyl ethyl ketone and acetone. These solvents can be used alone or in combination.

Specific examples of the coating method for use in preparing the charge transport layer include known coating methods such as spray coating, bead coating, nozzle coating, spinner coating, and ring coating.

The thickness of the charge transport layer is preferably not greater than 50 μm, and more preferably not greater than 25 μm so that the resultant photoreceptor has good sensitivity while producing high resolution images. The lower limit of the thickness of the charge transport layer changes depending on the image forming system (particularly, the potential of the charged photoreceptor) for which the photoreceptor is used, but is generally not less than 5 μm.

Next, the outermost layer will be described.

Specific examples of the materials for use in the outermost layer include resins such as acrylonitrile-butadiene-styrene resins (ABS resins), acrylonitrile-chlorinated polyethylene-styrene resins (ACS resins), olefin-vinyl monomer copolymers, chlorinated polyether resins, aryl resins, phenolic resins, polyacetal resins, polyamide resins, polyamideimide resins, polyacrylate resins, polyarylsulfone resins, poybutylene resins, polybutylene terephthalate resins, polycarbonate resins, polyethersulfone resins, polyethylene resins, polyethylene terephthalate resins, polyimide resins, acrylic resins, polymethylpentene resins, polypropylene resins, polyphenylene oxide resins, polysulfone resins, polystyrene resins, polyarylate resins, acrylonitrile-styrene resins (AS resins), butadiene-styrene resins, polyurethane resins, polyvinyl chloride resins, polyvinylidene chloride resins, and epoxy resins.

It is preferable that the outermost layer is a crosslinked layer including a crosslinked resin such as urethane resins, phenolic resins, (meth)acrylic resins, siloxane resins, and epoxy resins.

As mentioned above, when a crosslinked resin is used for the outermost layer, good abrasion resistance can be imparted to the photoreceptor, but oxidizing gasses can easily penetrate through the outermost layer because such a crosslinked resin has a three-dimensional network structure. Therefore blurred images tend to be easily formed. However, when a combination of a positive hole transport material having formula (2) and a compound having formula (2) is used, blurred images are hardly formed. Therefore, even when a crosslinked resin is used for the outermost layer of the photoreceptor of the present invention, formation of blurred images and increase of the job-to-job potential variation can be prevented.

When the outermost layer is a crosslinked layer, the outermost layer preferably includes a crosslinked material obtained from a polymerizable compound having a charge transport structure and a polymerizable compound having no charge transport structure, because the outermost layer has good charge transport property while having a good combination of abrasion resistance and scratch resistance, and therefore the photoreceptor can have a good combination of charge transport property, abrasion resistance and scratch resistance.

In this regard, “polymerization” is classified into chain polymerization and sequential polymerization, and in this application “polymerization” means chain polymerization. Specifically, in this application “polymerization” means unsaturated polymerization (polymerization of unsaturated compounds), ring-opening polymerization and isomerization polymerization, in which a polymerization reaction proceeds while the materials used for the reaction achieve a radical state or an ionic state at an intermediate stage of the reaction. In addition, polymerizable compounds mean compounds having a functional group, which can perform the above-mentioned polymerization. Crosslinking means that molecules of one or more monomers or oligomers form a bond (such as covalent bond) when receiving energy such as heat energy, energy of light (such as visible light and ultraviolet light) and energy of radiation (such as electron beams and γ-ray), thereby forming a three-dimensional network.

Specific examples of the crosslinkable resins include thermosetting resins which are crosslinked by heat, light crosslinking resins which are crosslinked by light, and electron beam crosslinking resins which are crosslinked by electron beams. If desired, a crosslinking agent, a catalyst, and/or a polymerization initiator, can be used in combination with polymerizable compounds.

In order to prepare a crosslinked outermost layer, the polymerizable compounds (such as monomers and oligomers) used therefor have to have a functional group capable of performing a polymerization reaction. Any functional groups capable of performing a polymerization reaction can be used, but functional groups capable of performing an unsaturated radical or ionic polymerization reaction or a ring-opening reaction are preferable.

Specific examples of the functional groups capable of performing an unsaturated radical or ionic polymerization reaction include groups such as C═C, C≡C, C═O, C═N and C≡N.

The ring-opening polymerization reaction means a reaction in which an unstable distorted ring such as carbon rings, oxo rings, and nitrogen-containing heterocyclic rings is opened and polymerized, thereby forming a chain polymer. In this regard, ions are typically used as active species.

Specific examples of the functional groups capable of performing an unsaturated radical or ionic polymerization reaction and the ring-opening polymerization functional groups include groups having a C—C double bond such as (meth)acryloyl and vinyl groups, and groups causing a ring-opening polymerization reaction such as silanol groups and cyclic ether groups. In addition, ring-opening reactions caused by a reaction of two or more molecules can also be used.

In a crosslinking reaction, as the number of functional groups of a reactive monomer per a molecule increases, the resultant three-dimensional network becomes strong, and therefore monomers having three or more functional groups are preferable. By using tri- or more-functional monomers, the resultant crosslinked layer has high crosslinking density. Therefore, the outermost layer has high hardness, high elasticity and good smoothness, and the resultant photoreceptor has good durability and can produce high quality images.

When a crosslinked outermost layer is prepared using a polymerizable compound having no charge transport structure and a polymerizable compound having a charge transport structure, any known polymerizable compounds can be used therefor. Namely, good effects can be produced independently of the compounds used and the polymerizing method used. Among crosslinkable resins, acrylic resins and methacrylic resins are preferable because the resultant crosslinked layer has a good combination of abrasion resistance and scratch resistance, and the effects of the present invention can be satisfactorily produced.

When a polymerizable compound having no charge transport structure and a polymerizable compound having a charge transport structure are subjected to a crosslinking reaction, a three-dimensionally developed network can be formed. In addition, it is preferable to use a crosslinking agent, a catalyst, and/or a polymerization initiator, because the cross-linkage density of the resultant layer can be further enhanced and therefore the abrasion resistance of the outermost layer can be enhanced. In addition, since the number of unreacted functional groups can be decreased, the electrostatic properties of the photoreceptor are not deteriorated. Further, since the crosslinking reaction can be homogenously performed, the resultant outermost layer hardly has cracks or distortion, and therefore the resultant photoreceptor has a good combination of cleanability and durability while producing high resolution images.

Any known polymerizable compounds having a charge transport structure and a functional group capable of reacting with the polymerizable compound having no charge transport structure used can be used for the polymerizable compound having a charge transport structure. In this regard, the charge transport structure means a charge transport structure, which a charge transport material has and by which charge transportability can be developed. The charge transport structure is broadly classified into a hole transport structure and an electron transport structure. In the present invention, the charge transport structure includes both the hole transport structure and the electron transport structure.

The polymerizable compound having a charge transport structure used for forming the outermost layer can have one or more charge transport structures therein, and polymerizable compounds having plural charge transport structures are preferably used because the resultant photoreceptor has better charge transportability.

In addition, polymerizable compounds having both a hole transport structure and an electron transport structure (i.e., compounds having a bipolar property) can also be used for the photoreceptor of the present invention.

Specific examples of the materials (or groups) having a hole transport structure include known materials (or groups) having an electron donating property such as poly-N-vinyl carbazole, poly-γ-carbazolylethylglutamate, pyrene-formaldehyde condensation products, polyvinyl pyrene, polyvinyl phenanthrene, polysilane, oxazole, oxadiazole, imidazole, monoarylamine, diarylamine, triarylamine, stilbene, α-phenyl stilbene, benzidine, diarylmethane, triarylmethane, 9-styrylanthracene, pyrazoline, divinyl benzene, hydrazone, indene, butadiene, pyrene, bisstilbene and enamine. Specific examples of the materials (or groups) having an electron transport structure include known materials (or groups) having an electron accepting property such as chloranil, bromanil, tetracyanoethylene, tetracyanoquinodimethane, 2,4,7-trinitro-9-fluorenon, 2,4,5,7-tetranitro-9-fluorenon, 2,4,5,7-tetranitroxanthone, 2,4,8-trinitrothioxanthone, 2,6,8-trinitro-4H-indeno[1,2-b]thiophene-4-one, 1,3,7-trinitrodibenzothiophene-5,5-dioxide, condensed polycyclic quinone, diphenoquinone, benzoquinone, naphthalene tetracarboxylic acid diimide, and aromatic rings having a cyano group or a nitro group.

Next, acrylic resins will be described as an example of the crosslinkable resin.

The polymerizable compound having no charge transport structure is a compound, which does not have a positive-hole transport structure (such as structures of triarylamine, hydrazone, pyrazoline, and carbazole), and an electron transport structure (such as structures of condensed polycyclic quinone, diphenoxyquinone, and aromatic rings having a cyano group or a nitro group) and which has a radically polymerizable functional group. Any known groups, which have a C—C double bond and which can perform polymerization, can be used as the radically polymerizable functional group, and acryloyloxy and methacryloyloxy groups are preferable.

The more the number of functional groups of the polymerizable compound having no charge transport structure, the better, and polymerizable compounds having three or more functional groups are preferably used. When a polymerizable monomer having three or more functional groups is crosslinked, the resultant layer has a well-developed three dimensional network. Therefore, the resultant outermost layer has high hardness, high elasticity and good smoothness, and the resultant photoreceptor has a good combination of abrasion resistance and scratch resistance. However, depending on the crosslinking conditions and the materials used, a number of bonds are formed in a moment in the crosslinking reaction, and therefore an internal stress is generated in the resultant layer due to volume contraction, thereby often causing problems in that cracks are formed in the layer and the layer is peeled from the photoreceptor. In such a case, it is preferable to use a polymerizable monomer having one or two functional groups in combination with a polymerizable monomer having three or more functional groups.

Polymerizable compounds having three or more functional groups, which can be preferably used for enhancing the abrasion resistance will be described.

For example, a compound having three or more acryloyloxy groups can be prepared by subjecting a compound having three or more hydroxyl groups therein and one of acrylic acid (or a salt thereof), an acrylic halide, and an acrylate to an esterification reaction or an ester exchange reaction. In addition, a compound having three or more methacryloyloxy groups can also be prepared by a similar method. In this regard, the three or more functional groups may be the same or different from each other.

Specific examples of the polymerizable tri- or more-functional compounds having no charge transport structure include, but are not limited thereto, trimethylolpropane triacrylate (TMPTA), trimethylolpropane trimethacylate, alkylene (HPA)-modified trimethylolpropane triacrylate, ethylene oxy (EO)-modified trimethylolpropane triacrylate, propyleneoxy (PO)-modified trimethylolpropane triacrylate, caprolactone-modified trimethylolpropane triacrylate, HPA-modified trimethylolpropane trimethacrylate, pentaerythritol triacrylate, pentaerythritol tetraacrylate (PETTA), glycerol triacrylate, epichlorohydrin (ECH)-modified glycerol triacrylate, EO-modified glycerol triacrylate, PO-modified glycerol triacrylate, tris(acryloxyethyl)isocyanurate, dipentaerythritol hexaacrylate (DPHA), caprolactone-modified dipentaerythritol hexaacrylate, dipentaerythritol hydroxypentaacrylate, alkylated dipentaerythritol pentaacrylate, alkylated dipentaerythritol tetraacrylate, alkylated dipentaerythritol triacrylate, dimethylolpropane tetraacrylate (DTMPTA), pentaerhythritol ethoxytetracry late, EO-modified triacryl phosphate, and 2,2,5,5-tetrahydroxymethylcyclopentanone tetraacrylate. These compounds can be used alone or in combination. The reason why modification is performed on the compounds is to decrease the viscosity of the compounds so that the compounds are easy to handle.

In order to form a dense crosslinked network in the outermost layer, the ratio (Mw/F) of the molecular weight (Mw) of a radically polymerizable compound having no charge transport structure to the number of functional groups (F) included in a molecule of the compound is preferably not greater than 250. In this case, the abrasion resistance of the resultant photoreceptor can be enhanced. When the ratio is greater than 250, the resultant outermost layer tends to become soft and thereby the abrasion resistance of the layer is slightly deteriorated. In this case, it is not preferable to use only one monomer modified with a long chain group such as ethylene oxy (EO), propylene oxy (PO) and alkylene (HPA) groups.

The content of the unit obtained from a polymerizable tri- or more-functional compound having no charge transport structure in the crosslinked outermost layer is preferably from 20% to 80% by weight, and more preferably from 30% to 70% by weight, based on the total weight of the outermost layer. When the content is lower than 20% by weight, the three dimensional cross-linkage density is low, and therefore the resultant outermost layer cannot have much better abrasion resistance than conventional outermost layers prepared by using a thermoplastic binder resin. In contrast, when the content is higher than 80% by weight, the content of the charge transport compound in the outermost layer decreases, thereby deteriorating the electrostatic properties of the photoreceptor (e.g., irradiated-portion potential of the photoreceptor is increased). Since the targets of the abrasion resistance and electrostatic properties of the crosslinked outermost layer are determined depending on the image forming processes of the apparatus for which the photoreceptor is used, the content of the unit obtained from the polymerizable compound having no charge transport structure in the outermost layer is not unambiguously determined. However, the content is preferably from 30% to 70% by weight in order to balance both the properties.

Next, the polymerizable compound having a charge transport structure will be described in detail.

The radically polymerizable compound having a charge transport structure for use in the outermost layer is a compound which has a positive hole transport structure such as structures of triarylamine, hydrazone, pyrazoline and carbazole, and/or an electron transport structure such as structures of condensed polycyclic quinone, diphenoquinone, and electron accepting aromatic rings having a cyano group or a nitro group and which has a radically polymerizable functional group. Any known polymerizable groups having a C—C double bond can be used as the radically polymerizable functional group, and acryloyloxy and methacryloyloxy groups are preferable among the polymerizable groups.

The number of functional groups of the radically polymerizable compound having a charge transport structure is not particularly limited, but monofunctional compounds are preferable because the resultant photoreceptor can have good electrostatic property stability and the resultant outermost layer has good property as a film. When a di- or more-functional compound is used, the cross-linkage density of the crosslinked network can be enhanced, but the resultant crosslinked layer has large distortion because the charge transport structure is very bulky, thereby increasing the internal stress of the layer. In addition, since the resultant layer cannot stably achieve an intermediate structure (i.e., a cation-radical state) in the charge transport process, charges are easily trapped, thereby deteriorating the photosensitivity of the photoreceptor and increasing the irradiated-portion potential of the photoreceptor.

Any charge transport structures can be used as the charge transport structure of the radically polymerizable compound. Among various transport structures, triarylamine structures are preferable because of producing good effects.

The content of the unit obtained from a radically polymerizable compound having a charge transport structure in the crosslinked outermost layer is preferably from 20% to 80% by weight, and more preferably from 30% to 70% by weight, based on the total weight of the outermost layer. When the content is lower than 20% by weight, the outermost layer tends to have insufficient charge transportability, thereby deteriorating the electrostatic properties of the photoreceptor (e.g., the photosensitivity of the photoreceptor deteriorates and irradiated-portion potential of the photoreceptor increases). In contrast, when the content is higher than 80% by weight, the content of the unit obtained from a radically polymerizable compound having no charge transport structure compound in the outermost layer decreases, thereby decreasing the three dimensional cross-linkage density of the outermost layer, resulting in deterioration of the abrasion resistance of the outermost layer. Since the targets of the abrasion resistance and electrostatic properties of the crosslinked outermost layer are determined depending on the image forming processes of the apparatus for which the photoreceptor is used, the content of the unit obtained from the polymerizable compound having a charge transport structure in the outermost layer is not unambiguously determined. However, the content is preferably from 30% to 70% by weight in order to balance both the properties.

The crosslinked outermost layer is preferably prepared by reacting (crosslinking) at least a radically polymerizable monomer having no charge transport structure and a radically polymerizable compound having a charge transport structure. However, in order to reduce the viscosity of the outermost layer coating liquid, to relax the stress of the outermost layer, and to reduce the surface energy and friction coefficient of the outermost layer, known radically polymerizable mono- or di-functional monomers and oligomers having no charge transport structure, and/or mono- or di-functional functional monomers for use in imparting a special function such as low surface energy and/or low friction coefficient to the outermost layer can be used in combination therewith.

Specific examples of the radically polymerizable monofunctional monomers having no charge transport structure include 2-ethylhexyl acrylate, 2-hydroxyethyl acrylate, 2-hydroxypropyl acrylate, tetrahydrofurfuryl acrylate, 2-ethylhexylcarbitol acrylate, 3-methoxybutyl acrylate, benzyl acrylate, cyclohexyl acrylate, isoamyl acrylate, isobutyl acrylate, methoxytriethyleneglycol acrylate, phenoxytetraethyleneglycol acrylate, cetyl acrylate, isostearyl acrylate, stearyl acrylate and styrene.

Specific examples of the radically polymerizable difunctional monomers having no charge transport structure include 1,3-butanediol diacrylate, 1,4-butanediol diacrylate, 1,4-butanediol dimethacrylate, 1,6-hexanediol diacrylate, 1,6-hexanediol dimethacrylate, diethylene glycol diacrylate, neopentylglycol diacrylate, binsphenol A-ethyleneoxy-modified diacrylate, bisphenol F-ethyleneoxy-modified diacrylate, and neopentylglycol diacrylate.

Specific examples of the functional monomers for use in imparting a special function such as low surface energy and/or low friction coefficient to the outermost layer include fluorine-containing monomers such as octafluoropentyl acrylate, 2-perfluorooctylethyl acrylate, 2-perfluorooctylethyl methacrylate, and 2-perfluoroisononylethyl acrylate; and vinyl monomers, acrylates and methacrylates, which are described in published examined Japanese patent applications Nos. H05-60503 and H06-45770 and which have a polysiloxane group such as siloxane units having a repeat number of from 20 to 70 (e.g., acryloylpolydimethylsiloxaneethyl, methacryloylpolydimethylsiloxaneethyl, acryloylpolydimethylsiloxanepropyl, acryloylpolydimethylsiloxanebutyl, and diacryloylpolydimethylsiloxanediethyl).

Specific examples of the radically polymerizable oligomers include epoxyacrylate oligomers, urethane acrylate oligomers, and polyester acrylate oligomers.

When a large amount of a radically polymerizable mono- or di-functional monomer or oligomer is used, the three dimensional cross-linkage density of the outermost layer tends to decrease, thereby deteriorating the abrasion resistance of the outermost layer. Therefore, the added amount of such a monomer or oligomer is preferably not greater than 50 parts by weight, and preferably 30 parts by weight, per 100 parts by weight of the radically polymerizable tri- or more-functional monomer included in the outermost layer coating liquid.

A crosslinked outermost layer is typically prepared by coating a coating liquid including polymerizable monomers, and then polymerizing and crosslinking the monomers. In order to efficiently crosslink the outermost layer, a polymerization initiator can be added to the outermost layer coating liquid. Suitable polymerization initiators include heat polymerization initiators and photopolymerization initiators. The polymerization initiators can be used alone or in combination.

Specific examples of the heat polymerization initiators include peroxide initiators such as 2,5-dimethylhexane-2,5-dihydroperoxide, dicumyl peroxide, benzoyl peroxide, t-butylcumyl peroxide, 2,5-dimethyl-2,5-di(peroxybenzoyl)hexyne-3, di-t-butylperoxide, t-butylhydroperoxide, cumenehydroperoxide and lauroyl peroxide; and azo type initiators such as azobisisobutyronitrile, azobiscyclohexanecarbonitrile, azobisbutyric acid methyl ester, hydrochloric acid salt of azobisisobutylamidine, and 4,4′-azobis-cyanovaleric acid.

Specific examples of the photopolymerization initiators include acetophenone or ketal type photopolymerization initiators such as diethoxyacetophenone, 2,2-dimethoxy-1,2-diphenylethane-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenylpropane-1-one, 2-methyl-2-morpholino(4-methylthiophenyl)propane-1-one, and 1-phenyl-1,2-propanedione-2-(o-ethoxycarbonyl)oxime; benzoin ether type photopolymerization initiators such as benzoin, benzoin methyl ether, benzoin ethyl ether, benzoin isobutyl ether, and benzoin isopropyl ether; benzophenone type photopolymerization initiators such as benzophenone, 4-hydroxybenzophenone, o-benzoylbenzoic acid methyl ester, 2-benzoyl naphthalene, 4-benzoyl biphenyl, 4-benzoyl phenyl ether, acrylated benzophenone, and 1,4-benzoyl benzene; thioxanthone type photopolymerization initiators such as 2-isopropylthioxanthone, 2-chlorothioxanthone, 2,4-dimethylthioxanthone, 2,4-diethylthioxanthone, and 2,4-dichlorothioxanthone; and other photopolymerization initiators such as ethylanthraquinone, 2,4,6-trimethylbenzoyldiphenylphosphineoxide, 2,4,6-trimethylbenzoylphenylethoxyphosphineoxide, bis(2,4,6-trimethylbenzoyl)phenylphosphineoxide, bis(2,4-dimethoxybenzoyl)-2,4,4-trimethylpentylphosphineoxide, methylphenylglyoxyester, 9,10-phenanthrene, acridine compounds, triazine compounds, and imidazole compounds.

Photopolymerization accelerators can be used alone or in combination with the above-mentioned photopolymerization initiators. Specific examples of the photopolymerization accelerators include triethanolamine, methyldiethanolamine, ethyl 4-dimethylaminobenzoate, isoamyl 4-dimethylaminobenzoate, 2-dimethylaminoethyl benzoate, and 4,4′-dimethylaminobenzophenone.

The added amount of such a polymerization initiator is preferably from 0.5 to 40 parts by weight, and more preferably from 1 to 20 parts by weight, per 100 parts by weight of the total weight of the radically polymerizable compounds used.

The outermost layer of the photoreceptor of the present invention can include a filler therein. By dispersing a filler in the outermost layer, the abrasion resistance and scratch resistance of the outermost layer can be improved, resulting in improvement of the life of the photoreceptor.

Organic and inorganic fillers can be used for the outermost layer. Specific examples of organic fillers for use in the outermost layer include powders of fluorine-containing resins such as polytetrafluoroethylene, powders of silicone resins, and particulate carbons (i.e., particulate materials including carbon as a main component). Specific examples of the particulate carbons include powders of carbons having a structure such as amorphous, diamond, graphite, fullerene, carbon nanotube, carbon Zeppelin, and nanohorn structures. Among these particulate carbons, diamond carbon or amorphous carbon, which include hydrogen, are preferable because of having good mechanical and chemical durability. Hydrogen-containing diamond carbon or amorphous carbon is particulate carbon having a mixed structure of a diamond structure having a SP3 orbital, a graphite structure having a SP2 orbital, and an amorphous structure. Diamond carbon or amorphous carbon can include elements other than carbon, such as hydrogen, oxygen, nitrogen, fluorine, boron, phosphorous, chlorine, chlorine, bromine and iodine.

Specific examples of inorganic fillers for use in the outermost layer include powders of metals such as copper, tin, aluminum and indium; powders of metal oxides such as silicon oxide (silica), tin oxide, zinc oxide, titanium oxide, alumina, zirconia, indium oxide, antimony oxide, and bismuth oxide; and other inorganic materials such as potassium titanate and boron nitride.

Among the organic and inorganic fillers, inorganic fillers are preferable because of having a high hardness. Particularly, metal oxides are preferable, and silica, alumina and titanium oxide are more preferable. In addition, fine particles of metal oxides such as colloidal silica and colloidal alumina can also be preferably used.

In addition, the filler included in the outermost layer can be subjected to a surface treatment to improve the dispersibility in the outermost layer coating liquid and the resultant outermost layer. When a filler is not well dispersed in the coating liquid, not only the irradiated-portion potential of the resultant photoreceptor increases, but also the outermost layer tends to have low transparency and coating defects, thereby deteriorating the electrostatic properties of the photoreceptor. In addition, good abrasion resistance cannot be imparted to the photoreceptor. Therefore, it is difficult for the photoreceptor to have good durability and to produce high resolution images. Any known treating agents can be used for the surface treatment.

The average primary particle diameter of the filler included in the outermost layer is preferably from 0.01 μm to 1.0 μm, and more preferably from 0.1 μm to 0.5 μm, in view of the light transmission property and the abrasion resistance of the outermost layer. When the average primary particle diameter of the filler is too small, particles of the filler tend to easily aggregate in the outermost layer coating liquid, resulting in deterioration of the abrasion resistance of the outermost layer. In addition, since the surface area of the filler increases, the irradiated-portion potential of the photoreceptor tends to increase. In contrast, when the average primary particle diameter is too large, the filler tends to easily precipitate in the coating liquid, resulting in formation of an uneven outermost layer. In addition, it is difficult for a photoreceptor having an outermost layer including such a large filler to produce high quality images (i.e., the photoreceptor forms defected images).

The content of a filler in the outermost layer is preferably from 0.1% to 50% by weight, more preferably from 3% to 30% by weight, and even more preferably from 5% to 20% by weight, based on the total weight of the solid components included in the outermost layer. When the content is too low, the abrasion resistance of the outermost layer is hardly improved. In contrast, when the filler content is too high, problems such that the irradiated-portion potential of the resultant photoreceptor increases, and image qualities (e.g., resolution) of images produced by the photoreceptor deteriorate tend to be caused.

When a filler is used for the outermost layer, a filler is subjected to a dispersing treatment together with at least an organic solvent, and an optional dispersant. In this regard, known dispersing methods using a dispersing machine such as ball mills, attritors, sand mills, and ultrasonic dispersing machines can be used. When a dispersing machine using a media is used, media such as zirconia, alumina and agate are preferably used. Among these media, alumina is preferable because a filler can be well dispersed in a solvent, and the irradiated-portion potential of the photoreceptor is hardly increased thereby. Further, α-alumina is more preferable because of having good abrasion resistance. In contrast, when zirconia is used as media for dispersing a filler, zirconia is easily abraded by the filler, and the abraded zirconia is included in the resultant dispersion and outermost layer coating liquid. When the outermost layer is formed using such a coating liquid, the resultant photoreceptor has a high irradiated-portion potential. In addition, since the filler cannot be well dispersed in the coating liquid due to inclusion of the abraded zirconia in the coating liquid, the filler is precipitated in the coating liquid, and therefore a desired outermost layer cannot be obtained. When alumina is used as media, the amount of abraded alumina is much smaller than in the case of zirconia. In addition, even when abraded alumina is included in the coating liquid, the irradiated-portion potential of the resultant photoreceptor is hardly increased thereby, and a filler can be well dispersed in the coating liquid (i.e., the abraded alumina hardly affects the dispersibility of a filler). Therefore, it is preferable to use alumina as media.

When a dispersant is used for dispersing a filler in an organic solvent, it is preferable to mix the dispersant with the filler and the organic solvent before a dispersing treatment, to satisfactorily disperse the filler in the solvent (coating liquid), i.e., to prevent agglomeration of the filler in the coating liquid and to prevent precipitation of the filler in the coating liquid. In contrast, other components such as a binder resin and a charge transport material can be mixed with the filler before the dispersing treatment. However, in this case, a problem in that the filler is not satisfactorily dispersed in the coating liquid is often caused, and therefore it is preferable to add such components to the organic solvent dispersion of the filler.

The outermost layer can include other additives such as antioxidants, plasticizers, leveling agents, lubricants and ultraviolet absorbents.

Specific examples of the antioxidants include phenolic compounds, hindered phenol compounds, hindered amine compounds, paraphenylenediamine compounds, hydroquinone compounds, sulfur-containing organic compounds, and phosphorous-containing organic compounds. The added amount of an antioxidant is preferably not greater than 10% by weight, and more preferably not greater than 5% by weight, based on the total weight of the solid components of the outermost layer coating liquid.

By including a plasticizer in the outermost layer, stress applied to the outermost layer can be relaxed, formation of a crack in the outermost layer can be prevented, and the outermost layer can be satisfactorily adhered to the lower layer such as the charge transport layer. Any known plasticizers for use in resins can be used. Specific examples thereof include dibutyl phthalate, and dioctyl phthalate. The added amount of a plasticizer is preferably not greater than 20% by weight, and more preferably not greater than 10% by weight, based on the total weight of the solid components of the outermost layer coating liquid.

By including a leveling agent in the outermost layer coating liquid, formation of coating defects can be prevented, and the outermost layer has uniform thickness. In addition, since the surface of the outermost layer has good lubricating property, formation of a film (such as a toner film) on the outermost layer and adhesion of foreign materials to the outermost layer can be prevented. Specific examples of the leveling agent include silicone oils (such as dimethylsilicone oils, and methylphenylsilicone oils), and polymers and oligomers having a perfluoroalkyl group in their side chains. Among these leveling agents, leveling agents having a polymerizable group are preferable. The added amount of a leveling agent is preferably not greater than 3% by weight based on the total weight of the solid components of the outermost layer coating liquid.

The outermost layer is typically prepared by coating an outermost layer coating liquid using a known coating method such as spray coating, dip coating, ring coating, and bead coating. Among these coating methods, spray coating is preferable because a uniform thin layer can be formed. The coating liquid can include a solvent, which is used for dissolving a binder resin or diluting the coating liquid.

Specific examples of the solvent include alcohols such as methanol, ethanol, propanol and butanol; ketones such as acetone, methyl ethyl ketone, methyl isobutyl ketone and cyclohexanone; esters such as ethyl acetate and butyl acetate; ethers such as tetrahydrofuran, dioxane and propyl ether; halogenated solvents such as dichloromethane, dichloroethane, trichloroethane and chlorobenzene; aromatic solvents such as benzene, toluene and xylene; and cellosolves such as methyl cellosolve, ethyl cellosolve and cellosolve acetate. These solvents can be used alone or in combination. The added amount of a solvent is determined depending on the solubility of the components, coating methods, and the target thickness of the outermost layer, but is typically not less than 15% by weight based on the total weight of the coating liquid.

The thickness of the outermost layer is preferably from 1 μm to 10 μm, and more preferably from 2 μm to 6 μm. When the thickness is less than 1 μm, the outermost layer has insufficient durability. When the thickness is greater than 10 μm, the irradiated-portion potential of the photoreceptor tends to increase.

When a crosslinked outermost layer is formed, the outermost layer coating liquid is coated, and then energy is externally applied to the coated layer to crosslink the outermost layer. In this regard, suitable external energy includes heat energy, light energy and radiation energy.

When heat crosslinking is performed, methods in which the coated layer and/or the substrate supporting the coated layer are heated using a heated gas (such as air, nitrogen and steam), a heating medium, infrared rays or electromagnetic waves can be used. In this case, the temperature is preferably from 100° C. to 170° C. When the temperature is too low, the reaction speed is slow, and the crosslinking reaction is not completely performed. In contrast, when the temperature is too high, the crosslinking reaction unevenly proceeds, thereby causing a problem in that a large strain is formed in the resultant crosslinked outermost layer. In order to prepare an evenly crosslinked outermost layer, it is preferable to perform first heating at a relatively low temperature of lower than 100° C., followed by second heating at a relatively high temperature of not lower than 100° C.

When photo-crosslinking is performed, light sources such as high pressure mercury lamps and metal halide lamps emitting UV light are preferably used. It is possible to use light source emitting visible light when the polymerizable compounds and polymerization initiators can absorb visible light. The intensity of light is not less than 50 mW/cm², preferably not less than 500 mW/cm², and more preferably not less than 1000 mW/cm². When the intensity is greater than 1000 mW/cm², the polymerization reaction can be performed at a high speed, and a uniform outermost layer can be formed.

When radiation crosslinking is performed, electron beams are typically used.

When photo-crosslinking or radiation crosslinking is performed, it is preferable to heat the crosslinked outermost layer to remove residual solvents therefrom. In this regard, the heating temperature and heating time are determined depending on the solvent used for the outermost layer coating liquid, but the heating temperature is generally from 100° C. to 150° C., and the heating time is generally from 10 minutes to 30 minutes.

The photoreceptor of the present invention can have an undercoat layer between the electroconductive substrate 31 and the charge generation layer 35.

The undercoat layer includes a resin as a main component. Since the charge generation layer is formed on the undercoat layer typically by coating a coating liquid including an organic solvent, the resin in the undercoat layer preferably has good resistance to general organic solvents.

Specific examples of such resins include water-soluble resins such as polyvinyl alcohol resins, casein and polyacrylic acid sodium salts; alcohol soluble resins such as nylon copolymers and methoxymethylated polyamides; and thermosetting resins capable of forming a three-dimensional network such as polyurethane resins, melamine resins, alkyd-melamine resins and epoxy resins.

The undercoat layer can include a powder of metal oxides to prevent occurrence of moiré in the resultant images and to decrease irradiated-portion potential of the resultant photoreceptor. Specific examples of the metal oxides include titanium oxide, silica, alumina, zirconium oxide, tin oxide and indium oxide.

The undercoat layer is typically formed by coating a coating liquid including a resin, an optional particulate material, and a proper solvent using a proper coating method such as the coating methods mentioned above for use in preparing the charge generation layer and the charge transport layer. The undercoat layer may be formed using a silane coupling agent, a titanium coupling agent or a chromium coupling agent. In addition, a layer of aluminum oxide which is formed by an anodic oxidation method, and a layer of an organic compound such as polyparaxylylene and an inorganic compound such as SiO₂, SnO₂, TiO₂, ITO and CeO₂, which is formed by a vacuum evaporation method, can also be preferably used as the undercoat layer. However, the undercoat layer is not limited thereto, and any known undercoat layers can also be used. The thickness of the undercoat layer is preferably 0 to 5 μm.

In order to improve coating properties of coating liquids for use in preparing the layers (such as the outermost layer, the charge generation layer, the charge transport layer, and the undercoat layer) of the photoreceptor and stability of the photoreceptor to withstand environmental conditions, and to prevent deterioration of photosensitivity and charging properties and increase of the irradiated-portion potential of the photoreceptor, the photoreceptor can include additives such as antioxidants, plasticizers, lubricants, ultraviolet absorbents, and leveling agents in one or more of the layers of the photoreceptor.

Next, the image forming method and apparatus of the present invention will be described. The image forming method of the present invention uses the photoreceptor of the present invention and includes at least charging the photoreceptor, irradiating the charged photoreceptor with light to form an electrostatic latent image on the photoreceptor, developing the electrostatic latent image with a developer including a toner to form a toner image on the photoreceptor, and then transferring the toner image onto a receiving material such as an intermediate transfer medium or a recording material. The image forming method optionally includes fixing the toner image on the recording material, and cleaning the surface of the photoreceptor after transferring the toner image.

The image forming apparatus of the present invention includes the photoreceptor of the present invention, and at least a charger to charge the photoreceptor, an irradiator to irradiate the charged photoreceptor with light to form an electrostatic latent image on the photoreceptor, a developing device to develop the electrostatic latent image with a developer including a toner to form a toner image on the photoreceptor, and a transferring device to transfer the toner image onto a receiving material such as an intermediate transfer medium or a recording material. The image forming apparatus optionally includes a fixing device to fix the toner image on the recording material, and a cleaner to clean the surface of the photoreceptor after transferring the toner image. The image forming apparatus can have plural image forming units each including at least the photoreceptor, the charger, the developing device, and the transferring device to form multiple color images.

FIG. 2 illustrates the image forming section of an example of the image forming apparatus of the present invention.

Referring to FIG. 2, the image forming section includes a photoreceptor 1 which serves as an image bearing member and which is the above-mentioned photoreceptor of the present invention, a charger 3 to charge a surface of the photoreceptor 1, an irradiator 5 to irradiate the charged surface of the photoreceptor with light to form an electrostatic latent image on the surface of the photoreceptor 1, a developing device 6 to develop the electrostatic latent image with a developer including a toner to form a toner image on the surface of the photoreceptor 1, a transferring device to transfer the toner image onto a recording material 9 using a transfer charger 10 while separating the recording material from the photoreceptor 1 using a separation charger 11, a cleaning device to clean the surface of the photoreceptor 1 using a fur brush 14 and a blade 15 after transferring the toner image, and a discharger 2 to decay residual charges remaining on the surface of the photoreceptor after cleaning the surface. Reference numerals 8 and 12 respectively denote a pair of registration rollers to timely feed the recording material 9 to the transfer device 10 and 11, and a separation pick to separate the recording material 9 from the photoreceptor 1. Reference numeral 13 denotes a pre-cleaning charger to previously charge the photoreceptor 1 so that the surface of the photoreceptor 1 can be well cleaned by the cleaning device 14 and 15. Reference numeral 7 denotes a pre-transfer charger to previously charge the photoreceptor 1 so that the toner image can be well transferred onto the recording material 9.

The photoreceptor 1 has a drum form, but sheet-form or endless-belt-form photoreceptors can also be used in the present invention.

Suitable devices for use as the charger 3 include known chargers capable of uniformly charging the photoreceptor, such as corotrons, scorotrons, solid state dischargers, needle electrodes, charging rollers and electroconductive brush devices. Among these chargers, contact and non-contact short-range chargers are preferably used to prevent occurrence of short-range discharging between the charger 3 and the photoreceptor 1, which tends to decompose the components constituting the layers of the photoreceptor 1. In this regard, the short-range chargers are such that a charging member such as charging rollers is arranged in the vicinity of a photoreceptor while forming a gap of not greater than 200 μm therebetween to charge the photoreceptor. When the gap is too wide, the photoreceptor is unstably charged. In contrast, when the gap is too narrow, it is possible that the charging member is contaminated with toner particles remaining on the surface of the photoreceptor. Therefore, the gap is preferably from 10 μm to 200 μm, and more preferably from 10 μm to 100 μm.

After the photoreceptor 1 is charged by the charger 3, the photoreceptor is irradiated with the irradiator 5 to form an electrostatic latent image thereon. The irradiator 5 has a light source to irradiate the charged photoreceptor 1 with light. Suitable light sources for use in the irradiator 5 include fluorescent lamps, tungsten lamps, halogen lamps, mercury lamps, sodium lamps, light emitting diodes (LEDs), laser diodes (LDs), and light sources using electroluminescence (EL). In addition, in order to obtain light having a desired wave length range, filters such as sharp-cut filters, band pass filters, near-infrared cutting filters, dichroic filters, interference filters, and color temperature converting filters can be used for the irradiator 5.

Next, the developing device 6 develops the electrostatic latent image on the photoreceptor 1 with a developer including a toner to form a toner image on the photoreceptor 1. Suitable developing methods include dry developing methods (such as one component developing methods using a toner as a one-component developer, and two component developing methods using a two-component developer including a carrier and a toner), and wet developing methods.

When the photoreceptor 1, which is previously charged positively (or negatively), is exposed to light, an electrostatic latent image having a positive (or negative) charge is formed on the photoreceptor 1. When the latent image having a positive (or negative) charge is developed with a toner having a negative (or positive) charge, a positive image can be obtained. In contrast, when the latent image having a positive (negative) charge is developed with a toner having a positive (negative) charge, a negative image (i.e., a reversal image) can be obtained.

The transfer charger 10 transfers the toner image, which is formed on the photoreceptor 1 by the developing device 6, to the recording material 9, which is fed by the pair of registration rollers 8 to a transfer position. In order to satisfactorily perform the transfer operation, the pre-transfer charger 7 can be used. Suitable transfer methods include transfer methods using a transfer charger, electrostatic transfer methods using a bias roller, and mechanical transfer methods such as transfer methods using an adhesive force, and transfer methods using a pressure, and transfer methods using a magnetic force. The above-mentioned chargers for use as the charger 3 can be used for the electrostatic transfer methods.

The recording material 9, on which the toner image has been transferred, is separated from the photoreceptor 1 by the separation charger 11 and the separation pick 12. Other separation methods such as separation methods utilizing electrostatic attraction, separation methods using a belt end, separation methods including griping tip of a recording material, and separation methods utilizing curvature can also be used. The above-mentioned chargers can be used for the separation charger 11.

The recording material 9 bearing a toner image is then fed to a fixing device to fix the toner image onto the recording material. Known fixing devices such as fixing devices using a heat roller and a pressure roller, and fixing devices using a fixing belt, a heat roller and a pressure roller can be used.

When the toner image formed on the photoreceptor 1 by the developing device 6 is transferred onto the recording material 9, the entire toner image is not transferred onto the recording material 9, and toner particles remain on the surface of the photoreceptor 1. The residual toner is removed from the photoreceptor 1 by the fur brush 14 and cleaning blade 15. In order to satisfactorily clean the surface of the photoreceptor 1, the pre-cleaning charger 13 can be used. Other cleaning methods such as web cleaning methods and magnet brush cleaning methods can also be used. These cleaning methods can be used alone or in combination.

If necessary, the discharger 2 performs a discharging operation of decaying residual charges remaining on the surface of the photoreceptor after cleaning the surface. Suitable devices for use as the discharger 2 include discharging lamps and discharging chargers. The lamps mentioned above for use in the irradiator 5, and the chargers mentioned above for use in the charger 3 can be used for the discharger 2.

The image forming apparatus of the present invention can further include other devices such as a document reader to read the image of an original image with an image reader; a feeding device to feed the recording material 9 toward the photoreceptor 1; and a copy discharging device to discharge the recording material 9 bearing a fixed image thereon (i.e., a copy) from the image forming apparatus. Known document readers, feeding devices, and copy discharging devices can be used for the image forming apparatus of the present invention. In addition, the image forming apparatus may include an intermediate transfer medium, which receives a toner image from the photoreceptor and transfers the toner image onto the recording material.

The image forming section illustrated in FIG. 2 can be fixedly set in an image forming apparatus such as copiers, facsimiles and printers. However, the image forming section can be detachably attached to an image forming apparatus as a process cartridge.

The process cartridge of the present invention includes the above-mentioned photoreceptor of the present invention, and at least one of a charger, a developing device, a transferring device, a cleaner to clean the surface of the photoreceptor after transferring the toner image, and a discharger to discharge residual charges remaining on the photoreceptor after transferring the toner image, which are integrated into a single unit so as to be detachably attachable to an image forming apparatus.

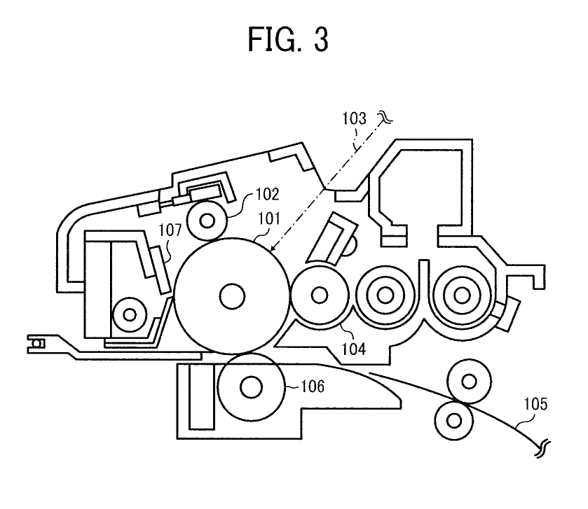

FIG. 3 illustrates an example of the process cartridge of the present invention, which includes a photoreceptor 101 which is the photoreceptor of the present invention.

Around the photoreceptor 101, a charger 102 (a charging roller) to charge the photoreceptor 101 which rotates clockwise; a developing device (developing roller) 104 to develop an electrostatic latent image with a developer including a toner to form a toner image on the photoreceptor 101; a transferring device 106 to transfer the toner image onto a recording material 105; and a cleaner including a blade 107 to clean the surface of the photoreceptor 101, are arranged. Numeral 103 denotes a light beam (emitted by an irradiator of an image forming apparatus) irradiating the photoreceptor 101 to form an electrostatic latent image thereon. The photoreceptor 101 may be subjected to a discharging process in which residual charges remaining on the photoreceptor 101 even after the transfer process are decayed by a discharger such as the above-mentioned discharging devices for use as the discharger 2.

Referring to FIG. 3, the photoreceptor 101, which is rotated clockwise, is charged by the charger 102, and then irradiated with the light beam 103 emitted by the irradiator, thereby forming an electrostatic latent image on the surface thereof. The developing device 104 develops the electrostatic latent image with a developer including a toner to form a toner image on the photoreceptor 101. The transferring device 106 transfers the toner image onto the recording material 105. Next, the cleaner 107 cleans the surface of the photoreceptor 101, and a discharger optionally performs the discharging treatment on the photoreceptor 101 so that the photoreceptor is ready for the next image forming operation.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Synthesis of Titanyl Phthalocyanine Crystal for Use as Charge Generation Material

A titanyl phthalocyanine crystal was prepared by the method described in published unexamined Japanese patent application No. 2004-83859. Specifically, in a container 292 parts of 1,3-diiminoisoindoline and 1,800 parts of sulfolane were mixed while agitated. Under a nitrogen gas flow, 204 parts of titanium tetrabutoxide was dropped therein. After titanium tetrabutoxide was added, the temperature of the mixture was gradually increased to 180° C. The mixture was agitated for 5 hours while maintaining the temperature in a range of from 170° C. to 180° C. to react the compounds. After the reaction was terminated, the reaction product was cooled. The reaction product was then filtered to obtain the precipitate. The precipitate was washed with chloroform until the precipitate colored blue. The precipitate was then washed with methanol several times, followed by washing with hot water of 80° C. several times, and drying. Thus, a crude titanyl phthalocyanine was prepared.

One part of the thus prepared crude titanyl phthalocyanine was gradually added to 20 parts of concentrated sulfuric acid to be dissolved therein. The solution was gradually added to 100 parts of ice water while agitated, to precipitate a titanyl phthalocyanine crystal. After the titanyl phthalocyanine crystal was obtained by filtering, the crystal was washed with ion-exchange water (having pH of 7.0 and a conductivity of 1.0 μS/cm) until the filtrate became neutral. In this case, the pH and conductivity of the final filtrate were 6.8 and 2.6 μS/cm. Thus, a wet cake (aqueous paste) of the titanyl phthalocyanine pigment was prepared.

Forty (40) parts of the thus prepared wet cake of the titanyl phthalocyanine pigment was added to 200 parts of tetrahydrofuran and the mixture was strongly agitated using a homomixer (MODEL MARK IIf from Kenis Ltd.), which was rotated at 2,000 rpm. When the color of the paste changed from dark blue to light blue (after agitation for about 20 minutes), agitation was stopped and the paste was subjected to filtering under a reduced pressure to obtain a crystal. In this regard, the solid content of the wet cake was 15% by weight. In this crystal change process, the ratio of the pigment to the crystal change solvent (tetrahydrofuran) was 1:33. The raw materials used for preparing the titanyl phthalocyanine pigment did not include a halogenated compound.

The crystal on the filter was washed with tetrahydrofuran to obtain a wet cake of a titanyl phthalocyanine crystal. The wet cake was dried for 2 days at 70° C. under a reduced pressure of 5 mmHg (666 Pa). Thus, 8.5 parts of a titanyl phthalocyanine crystal was prepared.

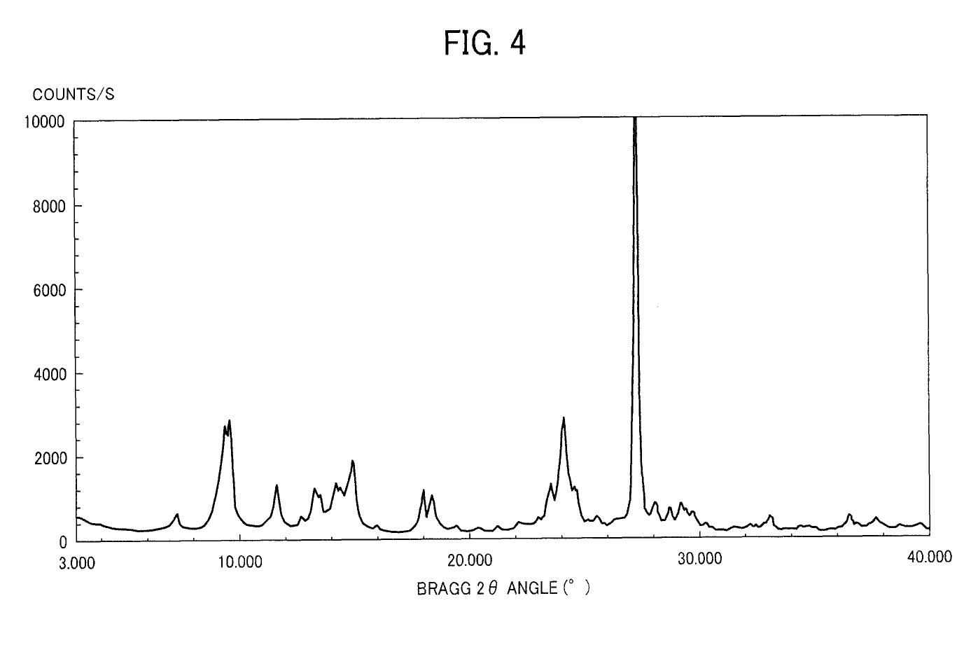

When the thus prepared titanyl phthalocyanine crystal was subjected to an X-ray diffraction analysis using a Cu-K α X-ray having a wavelength of 1.542 Å, the pigment had an X-ray diffraction spectrum such that a maximum peak is observed at a Bragg (2θ) angle of 27.2±0.2°, a lowest angle peak is observed at an angle of 7.3±0.2°, and a main peak is observed at each of angles of 9.4±0.2°, 9.6±0.2°, and 24.0±0.2°, wherein no peak is observed between the peaks of 7.3° and 9.4°, and at an angle of 26.3°±0.2°. The X-ray diffraction spectrum thereof is illustrated in FIG. 4.

The X-ray diffraction analysis was performed under the following conditions:

X-ray tube: Cu

Voltage: 50 kV

Current: 30 mA

Scanning speed: 2°/min

Scanning range: 3° to 40°

Time constant: 2 seconds

### Example 1

### Preparation of Undercoat Layer

The following components were mixed and the mixture was subjected to a dispersing treatment to prepare an undercoat layer coating liquid.

| | | |
|---|---|---|
| Titanium oxide powder | 400 | parts |
| (TIPAQUE CR-EL from Ishihara Sangyo Kaisha K.K.) | | |
| Melamine resin | 65 | parts |
| (SUPER BECKAMINE G821-60 from DIC Corp., | | |
| solid content of 60%) | | |
| Alkyd resin | 120 | parts |
| (BECKOLITE M6401-50 from DIC Corp., | | |
| solid content of 50%) | | |
| 2-Butanone | 400 | parts |

The undercoat layer coating liquid was coated on an aluminum drum having an outer diameter of 60 mm by a dip coating method, and the coated liquid was dried for 20 minutes in an oven heated to 130° C. Thus, an undercoat layer having a thickness of 3.5 μm was prepared.

### (Preparation of Charge Generation Layer)

The formula of the charge generation layer coating liquid is as follows.

| | | |
|---|---|---|
| Titanyl phthalocyanine crystal prepared above | 8 | parts |
| Polyvinyl butyral | 5 | parts |
| (S-LEC BX-1 from Sekisui Chemical Co., Ltd.) | | |
| 2-Butanone | 400 | parts |

At first, the polyvinyl butyral resin was dissolved in 2-butanone to prepare a polyvinyl butyral resin solution. Next, the titanyl phthalocyanine crystal was added to the resin solution and the mixture was dispersed for 30 minutes using a dispersing machine including PSZ balls with a particle diameter of 0.5 mm while the rotor was rotated at a revolution of 1,200 rpm. Thus, a charge generation layer coating liquid was prepared.

The charge generation layer coating liquid was coated on the undercoat layer by a dip coating method, and the coated liquid was dried for 20 minutes in an oven heated to 90° C. Thus, a charge generation layer having a thickness of 0.2 μm was prepared.

### (Preparation of Charge Transport Layer)

The following components were mixed to prepare a charge transport layer coating liquid.

| | | |
|---|---|---|
| Z-form polycarbonate | 10 | parts |
| (TS-2050 from Teijin Chemicals Ltd.) | | |
| Positive hole transport material | 11 | parts |
| (CTM3 described above) | | |
| Compound having formula ETM1 described above | 0.3 | parts |
| Tetrahydrofuran | 100 | parts |

The charge transport layer coating liquid was coated on the charge generation layer by a dip coating method, and the coated liquid was dried for 20 minutes in an oven heated to 120° C. Thus, a charge transport layer having a thickness of 25 μm was prepared.

### (Preparation of Crosslinked Outermost Layer)

The following components were mixed to prepare an outermost layer coating liquid.

| | | |
|---|---|---|
| Trimethylolpropane triacrylate | 10 | parts |
| (KAYARAD TMPTA from Nippon Kayaku Co., Ltd., serving as radically polymerizable compound having no charge transport structure) | | |
| Compound having the following formula (A) | 10 | parts |
| 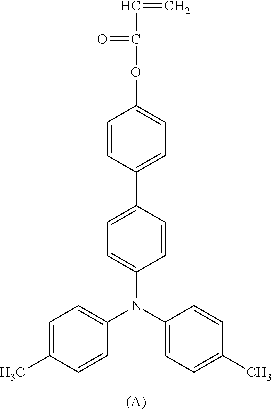 | | |
| Photopolymerization initiator | 1 | part |
| (1-hydroxycyclohexyl phenyl ketone, IRGACURE 184 from Ciba Specialty Chemicals) | | |
| Tetrahydrofuran | 100 | parts |

The outermost layer coating liquid was coated on the charge transport layer by a spray coating method, and the coated liquid was irradiated with light to be crosslinked. The light irradiation conditions were as follows.

Light source: metal halide lamp

Intensity of light: 500 mW/cm²

Irradiation time: 160 seconds

The outermost layer was further heated for 30 minutes at 130° C.

Thus, a crosslinked outermost layer having a thickness of 4 μm was prepared.

Thus, a photoreceptor of Example 1 was prepared.

### Example 2

The procedure for preparation of the photoreceptor in Example 1 was repeated except that the positive hole transport material CTM3 was replaced with the positive hole transport material CTM17 described above. Thus, a photoreceptor of Example 2 was prepared.

### Example 3

The procedure for preparation of the photoreceptor in Example 1 was repeated except that the positive hole transport material CTM3 and the compound ETM1 were replaced with the positive hole transport material CTM7 described above and the compound ETM3 described above, respectively. Thus, a photoreceptor of Example 3 was prepared.

### Example 4

The procedure for preparation of the photoreceptor in Example 1 was repeated except that the formulae of the charge transport layer coating liquid and the crosslinking outermost layer coating liquid were changed as follows.

| (Charge transport layer coating liquid) | | |
|---|---|---|
| Z-form polycarbonate | 10 | parts |
| (TS-2050 from Teijin Chemicals Ltd.) | | |
| Positive hole transport material | 11 | parts |
| (CTM14 described above) | | |
| Compound having formula ETM1 described above | 0.3 | parts |
| Tetrahydrofuran | 100 | parts |
| (Crosslinking outermost layer coating liquid) | | |
| Alumina | 3.0 | parts |
| (AA02 from Sumitomo Chemical Co., Ltd.) | | |
| Polymer of unsaturated polycarboxylic acid | 0.06 | parts |
| (BYK-P104 from BYK Chemie) | | |
| Trimethylolpropane triacrylate | 5 | parts |
| (KAYARAD TMPTA from Nippon Kayaku Co., Ltd., | | |
| serving as radically polymerizable compound having | | |
| no charge transport structure) | | |
| Dipentaerythritol caprolactone-modified hexaacrylate | 5 | parts |
| (KAYARAD DPCA-120 from Nippon Kayaku Co., Ltd., | | |
| serving as radically polymerizable compound having | | |
| no charge transport structure) | | |
| Compound having formula (A) mentioned above | 10 | parts |
| Photopolymerization initiator | 1 | part |
| (1-hydroxycyclohexyl phenyl ketone, IRGACURE 184 | | |
| from Ciba Specialty Chemicals) | | |
| Tetrahydrofuran | 100 | parts |

The outermost layer coating liquid was prepared by the following method.

Initially, the alumina, the polymer of unsaturated polycarboxylic acid, and 3 parts of tetrahydrofuran were contained in a 70 ml glass pot together with aluminum balls having a diameter of 5 mm, and the glass pot was rotated for 24 hours at a revolution of 150 rpm to prepare a dispersion. The dispersion was mixed with the other components and 97 parts of tetrahydrofuran to prepare the crosslinking outermost layer coating liquid.

Thus, a photoreceptor of Example 4 was prepared.

### Example 5

The procedure for preparation of the photoreceptor in Example 4 was repeated except that the compound ETM1 was replaced with the compound ETM4 described above. Thus, a photoreceptor of Example 5 was prepared.

### Example 6

The procedure for preparation of the photoreceptor in Example 4 was repeated except that the positive hole transport material CTM14 and the compound ETM1 were replaced with the positive hole transport material CTM12 described above and the compound ETM5 described above, respectively. Thus, a photoreceptor of Example 6 was prepared.

### Example 7

The procedure for preparation of the photoreceptor in Example 4 was repeated except that the positive hole transport material CTM14 and the compound ETM1 were replaced with the positive hole transport material CTM27 described above and the compound ETM8 described above, respectively. Thus, a photoreceptor of Example 7 was prepared.

### Example 8

The procedure for preparation of the photoreceptor in Example 4 was repeated except that the positive hole transport material CTM14 and the compound ETM1 were replaced with the positive hole transport material CTM35 described above and the compound ETM9 described above, respectively. Thus, a photoreceptor of Example 8 was prepared.

### Example 9

The procedure for preparation of the photoreceptor in Example 4 was repeated except that the added amount of the compound ETM1 was changed from 0.3 parts to 0.06 parts. Thus, a photoreceptor of Example 9 was prepared.

### Example 10

The procedure for preparation of the photoreceptor in Example 4 was repeated except that the added amount of the compound ETM1 was changed from 0.3 parts to 0.1 parts. Thus, a photoreceptor of Example 10 was prepared.

### Example 11

The procedure for preparation of the photoreceptor in Example 4 was repeated except that the added amount of the compound ETM1 was changed from 0.3 parts to 0.5 parts. Thus, a photoreceptor of Example 11 was prepared.

### Example 12

The procedure for preparation of the photoreceptor in Example 4 was repeated except that the added amount of the compound ETM1 was changed from 0.3 parts to 1.0 part. Thus, a photoreceptor of Example 12 was prepared.

### Example 13

The procedure for preparation of the photoreceptor in Example 4 was repeated except that the crosslinked outermost layer was prepared by the following method.

### (Preparation of Crosslinked Outermost Layer)

The following components were mixed to prepare an outermost layer coating liquid.

| | | |
|---|---|---|
| Polyol | 20 | parts |
| (LZR-170 from Fujikura Kasei Co., Ltd., styrene-methyl methacrylate-hydroxyethyl methacrylate copolymer) | | |
| Compound having the following formula (B) | 20 | parts |
| 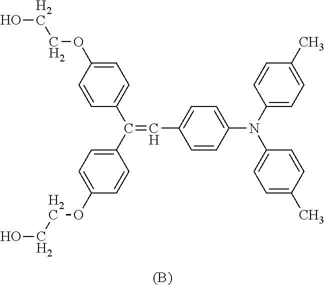 [SMILES: Cc1ccc(N(c2ccc(C)cc2)c2ccc(C=C(c3ccc(OCCO)cc3)c3ccc(OCCO)cc3)cc2)cc1 ; "(B)"] | | |
| Polyol adduct of tolylene diisocyanate | 38 | parts |
| (CORONATE L from Nippon Polyurethane Industry Co., Ltd.) | | |
| Silicone oil | 0.05 | parts |
| (KF50-100CS from Shin-Etsu Chemical Co., Ltd.) | | |
| Cyclohexanone | 50 | parts |
| Tetrahydrofuran | 200 | parts |

After the outermost layer coating liquid was coated on the charge transport layer by a spray coating method, the coated liquid was dried naturally for 1 minute, and then heated for 30 minutes at 150° C. to prepare a crosslinked outermost layer having a thickness of 5 μm.

Thus, a photoreceptor of Example 13 was prepared.

### Example 14

The procedure for preparation of the photoreceptor in Example 13 was repeated except that the formula of the outermost layer coating liquid was changed to the following.

| | | |
|---|---|---|
| Alumina | 3.0 | parts |
| (AA02 from Sumitomo Chemical Co., Ltd.) | | |
| Polymer of unsaturated polycarboxylic acid | 0.03 | parts |
| (BYK-P104 from BYK Chemie) | | |
| Compound having the following formula (C) | 4 | parts |
| 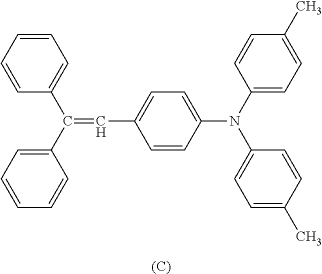 [SMILES: Cc1ccc(N(c2ccc(C)cc2)c2ccc(C=C(c3ccccc3)c3ccccc3)cc2)cc1 ; "(C)"] | | |
| Z-form polycarbonate | 5.5 | parts |
| (TS-2050 from Teijin Chemicals Ltd.) | | |
| Tetrahydrofuran | 220 | parts |
| Cyclohexanone | 80 | parts |

The outermost layer coating liquid was prepared by the same method mentioned above in Example 4.

Thus, a photoreceptor of Example 14 was prepared.

### Example 15

The procedure for preparation of the photoreceptor in Example 4 was repeated except that the added amount of the compound ETM1 was changed from 0.3 parts to 0.03 parts. Thus, a photoreceptor of Example 15 was prepared.

### Example 16

The procedure for preparation of the photoreceptor in Example 4 was repeated except that the added amount of the compound ETM1 was changed from 0.3 parts to 1.6 parts. Thus, a photoreceptor of Example 16 was prepared.

### Comparative Example 1

The procedure for preparation of the photoreceptor in Example 4 was repeated except that the charge transport layer coating liquid did not include the compound ETM1. Thus, a photoreceptor of Comparative Example 1 was prepared.

### Comparative Example 2

The procedure for preparation of the photoreceptor in Example 13 was repeated except that the charge transport layer coating liquid did not include the compound ETM1. Thus, a photoreceptor of Comparative Example 2 was prepared.

### Comparative Example 3

The procedure for preparation of the photoreceptor in Example 4 was repeated except that the positive hole transport material CTM14 was replaced with a positive hole transport material having the following formula (D).

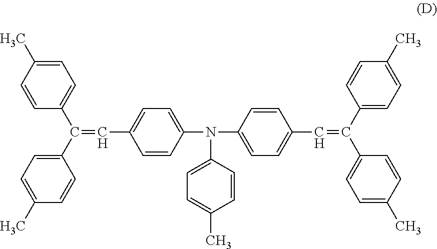 [SMILES: Cc1ccc(C(=Cc2ccc(N(c3ccc(C)cc3)c3ccc(C=C(c4ccc(C)cc4)c4ccc(C)cc4)cc3)cc2)c2ccc(C)cc2)cc1]

Thus, a photoreceptor of Comparative Example 3 was prepared.

### Comparative Example 4

The procedure for preparation of the photoreceptor in Example 4 was repeated except that the positive hole transport material CTM14 was replaced with the compound (charge transport material) having formula (C) mentioned above.

Thus, a photoreceptor of Comparative Example 4 was prepared.

### Comparative Example 5

The procedure for preparation of the photoreceptor in Example 4 was repeated except that the compound ETM1 was replaced with a compound having the following formula (E).

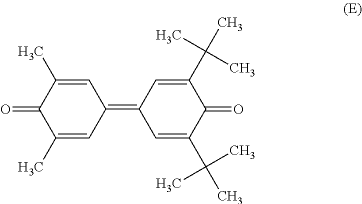 [SMILES: CC1=CC(=C2C=C(C(C)(C)C)C(=O)C(C(C)(C)C)=C2)C=C(C)C1=O]

Thus, a photoreceptor of Comparative Example 5 was prepared.

### Comparative Example 6

The procedure for preparation of the photoreceptor in Example 4 was repeated except that the compound ETM1 was replaced with a compound having the following formula (F).

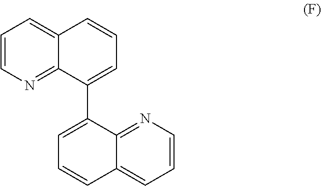 [SMILES: c1cnc2c(-c3cccc4cccnc34)cccc2c1]

Thus, a photoreceptor of Comparative Example 6 was prepared.

### Comparative Example 7

The procedure for preparation of the photoreceptor in Example 4 was repeated except that the compound ETM1 was replaced with a compound having the following formula (G).

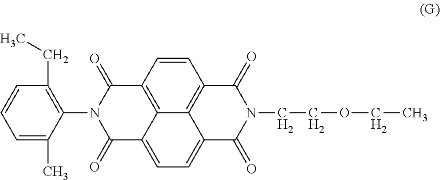 [SMILES: CCOCCN1C(=O)c2ccc3c4c(ccc(c24)C1=O)C(=O)N(c1c(C)cccc1CC)C3=O]

Thus, a photoreceptor of Comparative Example 7 was prepared.

### Comparative Example 8

The procedure for preparation of the photoreceptor in Example 4 was repeated except that the compound ETM1 was replaced with 1.0 part of a compound having the following formula (H).

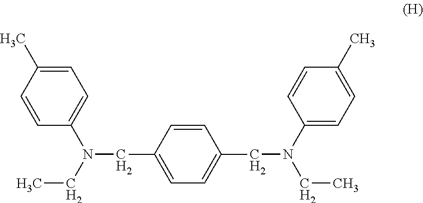 [SMILES: CCN(Cc1ccc(CN(CC)c2ccc(C)cc2)cc1)c1ccc(C)cc1]

Thus, a photoreceptor of Comparative Example 8 was prepared.

### Comparative Example 9

The procedure for preparation of the photoreceptor in Example 4 was repeated except that the charge transport layer coating liquid did not include the compound ETM1, and the formula of the outermost layer coating liquid was changed to the following.

| | | |
|---|---|---|
| Alumina | 3.0 | parts |
| (AA02 from Sumitomo Chemical Co., Ltd.) | | |
| Polymer of unsaturated polycarboxylic acid | 0.06 | parts |
| (BYK-P104 from BYK Chemie) | | |
| Trimethylolpropane triacrylate | 5 | parts |
| (KAYARAD TMPTA from Nippon Kayaku Co., Ltd., | | |
| serving as radically polymerizable compound having no | | |
| charge transport structure) | | |
| Dipentaerythritol caprolactone-modified hexaacrylate | 5 | parts |
| (KAYARAD DPCA-120 from Nippon Kayaku Co., Ltd., | | |
| serving as radically polymerizable compound having no | | |
| charge transport structure) | | |
| Compound having formula (A) | 10 | parts |
| Compound having formula (H) | 0.5 | part |
| Photopolymerization initiator | 1 | part |
| (1-hydroxycyclohexyl phenyl ketone, IRGACURE 184 | | |
| from Ciba Specialty Chemicals) | | |
| Tetrahydrofuran | 100 | parts |

Thus, a photoreceptor of Comparative Example 9 was prepared.

### Comparative Example 10

The procedure for preparation of the photoreceptor in Example 4 was repeated except that the outermost layer was not formed.

Thus, a photoreceptor of Comparative Example 10 was prepared.

Each of the photoreceptors was set in a process cartridge, and the process cartridge was set in a modified version of a tandem full color digital copier, IMAGIO MPC7500 from Ricoh Co., Ltd. Next, a running test, in which 500,000 copies of an original document in which characters are evenly described on the entire surface thereof in an image area proportion of 5% are produced, was performed. At the beginning and the end of the running test, the photoreceptor was evaluated with respect to the potential (VL) of an irradiated portion of the photoreceptor (irradiated-portion potential), and the job-to-job variation of the potential. In addition, the resolution of the image produced at the end of the running test was evaluated. The evaluation methods are as follows.

### (1) Irradiated Portion Potential (VL)

The irradiated-portion potential (VL) of the photoreceptor, which was charged by the charger and then irradiated with light emitted by the irradiator, was measured by an electrometer at the beginning and the end of the running test. The irradiated-portion potential is preferably not greater than 200V. In addition, the difference between the irradiated-portion potentials before and after the running test is preferably not greater than 20V.

### (2) Job-to-Job Potential Variation (VAjtj) of Irradiated Portion

After the irradiated-portion potential (VL1(=VL)) of the photoreceptor was measured at the beginning and the end of the running test, a print job in which 50 copies of the original document are continuously produced was repeated ten times, and then the irradiated-portion potential (VL2) was measured again to determine the job-to-job potential variation (VAjtj) of the irradiated-portion potential, i.e., VL2-VL1. The job-to-job potential variation of photoreceptor is graded as follows.

⊚: The irradiated-portion potential hardly varies. (Good)
◯: The irradiated-portion potential slightly varies, but the potential variation falls in a correctable range of the copier. (Acceptable)
Δ: The irradiated-portion potential clearly varies, and the potential variation falls out of the correctable range. (Unacceptable)
X: The irradiated-portion potential seriously varies. (Bad)

### (3) Resolution of Image

At the end of the running test, the image was visually observed using a microscope to determine the resolution of the image, i.e., to determine whether the image is blurred. The resolution of image is graded as follows.

⊚: The image has good resolution. (Good)
◯: The resolution of the image is slightly deteriorated, but is still on an acceptable level. (Acceptable)
Δ: The resolution of the image is clearly deteriorated so as to be on an unacceptable level. (Unacceptable)
X: The image is seriously blurred. (Bad)

The evaluation results are shown in Table 1 below.

TABLE 1

| | At the beginning of the | | At the end of the | | |
|---|---|---|---|---|---|
| | running test | | running test | | |
| | | Job-to-job | | Job-to-job | |
| | | potential | | potential | |
| | VL (−V) | variation (V) | VL (−V) | variation (V) | Resolution |
| Ex. 1 | 110 | 16 (⊚) | 124 | 19 (⊚) | ⊚ |
| Ex. 2 | 103 | 14 (⊚) | 120 | 20 (○) | ⊚ |
| Ex. 3 | 93 | 12 (⊚) | 115 | 17 (⊚) | ○ |
| Ex. 4 | 99 | 13 (⊚) | 113 | 16 (⊚) | ⊚ |
| Ex. 5 | 104 | 16 (⊚) | 119 | 22 (○) | ⊚ |
| Ex. 6 | 106 | 14 (⊚) | 120 | 19 (⊚) | ⊚ |
| Ex. 7 | 112 | 15 (⊚) | 128 | 26 (○) | ⊚ |
| Ex. 8 | 105 | 15 (⊚) | 118 | 25 (○) | ⊚ |
| Ex. 9 | 86 | 10 (⊚) | 99 | 14 (⊚) | ○ |
| Ex. 10 | 90 | 12 (⊚) | 104 | 15 (⊚) | ⊚ |
| Ex. 11 | 109 | 16 (⊚) | 121 | 19 (⊚) | ⊚ |
| Ex. 12 | 115 | 21 (○) | 126 | 23 (○) | ⊚ |
| Ex. 13 | 106 | 17 (⊚) | 130 | 28 (○) | ○ |
| Ex. 14 | 110 | 15 (⊚) | 130 | 27 (○) | ⊚ |
| Ex. 15 | 85 | 10 (⊚) | 96 | 13 (⊚) | Δ |
| Ex. 16 | 131 | 27 (○) | 151 | 31 (Δ) | ⊚ |
| Comp. | 85 | 10 (⊚) | 95 | 13 (⊚) | X |
| Ex. 1 | | | | | |
| Comp. | 96 | 15 (⊚) | 124 | 22 (○) | X |
| Ex. 2 | | | | | |
| Comp. | 110 | 17(⊚) | 135 | 31 (Δ) | Δ |
| Ex. 3 | | | | | |
| Comp. | 123 | 22(○) | 158 | 48 (X) | Δ |
| Ex. 4 | | | | | |
| Comp. | 99 | 18(⊚) | 124 | 39 (Δ) | X |
| Ex. 5 | | | | | |
| Comp. | 114 | 21(○) | 133 | 38 (Δ) | X |
| Ex. 6 | | | | | |
| Comp. | 102 | 17(⊚) | 119 | 34 (Δ) | X |
| Ex. 7 | | | | | |
| Comp. | 120 | 15(⊚) | 145 | 41 (X) | ⊚ |
| Ex. 8 | | | | | |
| Comp. | 125 | 17(⊚) | 142 | 46 (X) | ⊚ |
| Ex. 9 | | | | | |
| Comp. | 87 | 7(⊚) | —* | —* | —* |
| Ex. 10 | | | | | |

—*The properties could not be evaluated because the surface of the photoreceptor was
seriously abraded after the running test.

It is clear from Table 1 that the photoreceptors of Examples 1-14 can stably maintain good properties (i.e., the photoreceptors have relatively low potential (VL) and little job-to-job potential variation (VAjtj) without forming blurred images) even when repeatedly used for a long period of time.

The photoreceptor of Example 15, which includes a compound having formula (2) in a relatively small amount, produced slightly blurred images at the end of the running test. In contrast, the photoreceptor of Example 16, which includes a compound having formula (2) in a relatively large amount, did not produce blurred images, and the job-to-job potential variation (VAjtj) hardly increased even after the running test. However, the job-to-job potential variation (VAjtj) thereof was relatively high at the beginning and the end of the running test.

The photoreceptors of Comparative Examples 1 and 2, which do not include a compound having formula (2), produced blurred images, although the photoreceptors had relatively small job-to-job potential variation (VAjtj).

The photoreceptors of Comparative Examples 3 and 4, which include a positive hole transport material having a formula other than formula (1), and the photoreceptors of Comparative Examples 5-7, which include a compound having a formula different from formula (2), had large job-to-job potential variation and produced blurred images. In these photoreceptors, the interaction between the positive hole transport material and the compound is weak, and therefore deterioration of the photoreceptors caused by oxidizing gasses could not be prevented.

The photoreceptors of Comparative Examples 8 and 9, which use a compound having an alkylamino group for the charge transport layer or the crosslinked outermost layer, did not produce blurred images, but had large job-to-job potential variation.

The photoreceptor of Comparative Example 10, which has no outermost layer, had poor abrasion resistance, and therefore the photoreceptor could not be fully subjected to the running test.

Thus, the photoreceptor of the present invention has little potential variation and can produce high resolution images for a long period of time without forming blurred images.

In addition, the image forming method and apparatus, and the process cartridge of the present invention, which use the photoreceptor of the present invention, can produce images having little variation in image density and color tone while having good consistency in image qualities.

Additional modifications and variations of the present invention are possible in light of the above teachings. It is therefore to be understood that within the scope of the appended claims the invention may be practiced other than as specifically described herein.

What is claimed is:

1. An electrophotographic photoreceptor comprising:
an electroconductive substrate;
a charge generation layer located overlying the electroconductive substrate;
a charge transport layer located overlying the charge generation layer; and
an outermost layer located overlying the charge transport layer,
wherein the charge transport layer includes a positive hole transport material having the following formula (1): 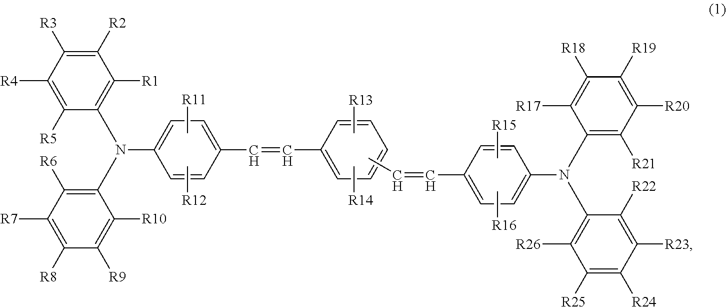
wherein each of R1 to R26 independently represents a hydrogen atom, an alkyl group having 1 to 4 carbon atoms, or an alkoxyl group having 1 to 4 carbon atoms, and a compound having the following formula (2): 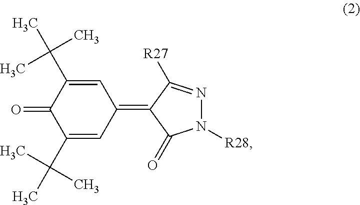
wherein each of R27 and R28 independently represents a substituted or unsubstituted alkyl group, or a substituted or unsubstituted aryl group.

2. The electrophotographic photoreceptor according to claim 1, wherein the outermost layer is a crosslinked outermost layer.

3. The electrophotographic photoreceptor according to claim 2, wherein the crosslinked outermost layer includes a unit obtained from a radically polymerizable compound having a charge transport structure, and a unit obtained from a radically polymerizable compound having no charge transport structure.

4. The electrophotographic photoreceptor according to claim 2, wherein the crosslinked outermost layer includes a filler.

5. The electrophotographic photoreceptor according to claim 1, wherein the compound having formula (2) is included in the charge transport layer in an amount of from 0.5 parts to 10 parts by weight based on 100 parts by weight of the positive hole transport material included in the charge transport layer.

6. An image forming method comprising:
charging a surface of the photoreceptor according to claim 1;
irradiating the charged surface of the photoreceptor with light to form an electrostatic latent image on the surface of the photoreceptor;
developing the electrostatic latent image with a developer including a toner to form a toner image on the surface of the photoreceptor; and
transferring the toner image onto a receiving material.

7. An image forming apparatus comprising:
the photoreceptor according to claim 1;
a charger to charge a surface of the photoreceptor;
an irradiator to irradiate the charged surface of the photoreceptor with light to form an electrostatic latent image on the surface of the photoreceptor;
a developing device to develop the electrostatic latent image with a developer including a toner to form a toner image on the surface of the photoreceptor; and
a transferring device to transfer the toner image onto a receiving material.

8. A process cartridge comprising:
the photoreceptor according to claim 1; and
at least one of a charger to charge a surface of the photoreceptor; a developing device to develop an electrostatic latent image on the surface of the photoreceptor with a developer including a toner to form a toner image on the surface of the photoreceptor; a transferring device to transfer the toner image onto a receiving material; a cleaner to clean the surface of the photoreceptor after transferring the toner image; and a discharger to discharge residual charges remaining on the surface of the photoreceptor after transferring the toner image,
wherein the process cartridge is a single unit so as to be detachably attachable to an image forming apparatus.
